(19) United States
(12) Patent Application Publication
(10) Pub. No.: US 2019/0138907 A1
(43) Pub. Date: May 9, 2019

(54) Unsupervised Deep Learning Biological Neural Networks

(71) Applicant: Harold Szu, Alexandria, VA (US)

(72) Inventor: Harold Szu, Alexandria, VA (US)

(21) Appl. No.: 15/983,078

(22) Filed: May 17, 2018

Related U.S. Application Data
(63) Continuation-in-part of application No. 15/903,729, filed on Feb. 23, 2018.
(60) Provisional application No. 62/462,356, filed on Feb. 23, 2017.

(51) Int. Cl. G06N 3/08; G06N 3/04; G06N 3/063; G05D 1/00; G05D 1/02

(52) U.S. Cl. CPC G06N 3/088; G06N 3/0427; G06N 3/0436; G05D 2201/0213; G05D 1/0088; G05D 1/0223; G06N 3/063

(57) ABSTRACT

An experience-based expert system includes an open-set neural net computing sub-system having massive parallel distributed hardware processing associated massive parallel distributed software configured as a natural intelligence biological neural network that maps an open set of inputs to an open set of outputs. The sub-system can be configured to process data according to the Boltzmann Wide-Sense Ergodicity Principle; to process data received at the inputs to determine an open set of possibility representations; to generate fuzzy membership functions based on the representations; and to generate data based on the functions and to provide the data at the outputs. An external intelligent system can be coupled for communication with the sub-system to receive the data and to make a decision based on the data. The external system can include an autonomous vehicle. The decision can determine a speed of the vehicle or whether to stop the vehicle.

### CROSS-REFERENCE TO RELATED APPLICATION

This is a continuation-in-part of U.S. patent application Ser. No. 15/903,729, which was filed on Feb. 23, 2018, which in turn was related to, and claimed priority from, U.S. Provisional Application for Patent No. 62/462,356, which was filed on Feb. 23, 2017, the entirety of which is incorporated herein by this reference.

### BACKGROUND OF THE INVENTION

Artificial intelligence (AI) has existed as a field of study for many years, and thus far there have been two generations of AI development. The first generation is exemplified by the five decade-old MIT Marvin Minsky rule-based “If so, then so” system. The second generation is exemplified by the more recent (March 2017) “learn-able rule-based system” with supervised learning, having labeled data “from A to B” that Alpha Brain used to beat a human (Korean genius Lee Sedol) in Go chess games by 4 to 1. Described herein is the third generation AI, which can co-exist and keep peace with humans, in driving trucks on the highway in a dedicated lane or eventually in driverless autonomous vehicle taxis in cities, and mobile robot nurses for home care seniors that must require an emotional intelligence (e-IQ) by acquiring features from the acoustic pitch tone of voices, facial expression (eye brow, mouth corners, etc.) image processing, and followed with multiple modality sensor fusion at the combined classification domain, in order to comprehend senior loneliness emotion stress feelings.

All these abstract emotional reactions must be represented in different types of Fuzzy Membership Functions (FMF) as the open sets of possibilities according to Fuzzy Logic Theory, which was first mentioned by Lotfi Zadeh and Walter Freeman of UC Berkeley in 1990. This position is in direct contrast against the closed set probability theory of Komogorov, which cannot be normalized as the closed set but can be described in the open set possibility theory. Some FMFs can be integrated.

According to a Dec. 15, 2017 Science Magazine article entitled “When will we get there?” it is estimated that the Level 4 Semi-Automation (man-in-the-loop) of the Driverless Autonomous Vehicle (DAV) (to distinguish from Automotive Vehicle (AV) we add Driverless) will not be achieved for another 13 years. Level 5 is the final stage, in which no human will be in the driver seat as co-driver, which will take a much longer time, in decades, to be realized. This lead-time is anticipated despite the early efforts of the NASA space landing of a Martian Cruiser, and DAPAR Grant Challenge of a road follower, that have mostly happened in “no-man's land,” as well as ongoing billions of dollars in investment by Google (Waymo Inc.) for driverless trucks and Uber driverless taxi business in a city. Recently, DAV accidents have killed a pedestrian. The shortfall of 2^{nd} Generation AI becomes clear.

### SUMMARY OF THE INVENTION

One of the shortfalls resulting in delay in proceeding to the next level of automation is that the computer automation science community is not yet familiar with “funnel orifice focusing logic” that begins with all possibility fuzzy membership function inputs and near the decision end provides a more focused result near the output end.

Thus, the new 3^{rd} generation, to co-exist peacefully with humans, must utilize human natural intelligence (NI) based on (a) the constant brain temperature (37° C. for optimum elasticity of oxygen-carried red blood cells known as hemoglobin) and (b) the power of pairs sensors in which the inputs that agree must be the signal, and those that disagree must be noise. Moreover, the constant temperature brain provides us with a thermal reservoir about 1/40 electronic Volt (eV) for steady physiological chemical reaction that any extra excitation energy of the external sensory inputs will be quickly relaxed to this thermal reservoir without need of supervision. These attributes (a) & (b) define human unsupervised learning, which is mathematically driven by a cost function at the minimum free energy (MFE).

Theorem: Human Unsupervised Learning operates at MFE.

Proof:

Total Boltzmann Entropy: Sₜₒₜ=k_{B} Log W_{MB} (1a)

Solving Eq. (1a) for the Maxwell-Boltzmann (MB) phase space volume W_{MB}, we derive for an isothermal system

$${W}_{MB} ≡ exp ( \frac{{S}_{tot}}{{k}_{B}} ) = exp ( \frac{( {S}_{brain} + {S}_{env .} ) {T}_{o}}{{k}_{B} {T}_{o}} ) = exp ( \frac{{S}_{brain} {T}_{o} - {E}_{brain}}{{k}_{B} {T}_{o}} ) = exp ( - \frac{{H}_{brain}}{{k}_{B} {T}_{o}} ) \qquad ( 1 b )$$

Use is made of the relationship that an exponential is the inverse of a logarithm and the isothermal equilibrium of the brain is kept at the heat reservoir at the homeostasis blood temperature Tₒ. Use is further made of the second law of thermodynamics: the conservation energy ΔQ_{env.}=TₒΔS_{env.} and the brain internal energy ΔE_{brain}+/Q_{env.}=0. We can keep or drop the Δ change, due to arbitrary probability normalization. The derived Helmholtz Free Energy H_{brain}(xₒ) is defined as the internal energy E of the system in contact with the heat blood bath at the temperature Tₒ. The H_{brain}(xₒ) must be the internal energy E(xₒ) subtracted the unusable thermal reservoir entropy energy TₒS and the net becomes the free-to-do work energy which must kept at a minimum to be stable. This is cost function of unsupervised learning Eq. (2)

min. ΔH_{brain}(xₒ)↓ΔE(xₒ)−TₒΔS(xₒ)↑ (2)
Q.E.D.

One more attribute that the 3^{rd} Gen AI must learn is humans believe a rule is made to be sensibly broken, as intelligent behavior. Such an analog thinking might appear to be inconsistent to a von Neumann digital computer operated by 2^{nd} Gen AI. To that end, there is a need for a system that tabulates all dynamic equation simulation results, for example, results from (1) Newtonian dynamics, (2) road-tire friction Langevin equation, (3) Lyaponov Control theory equation, (4) Global Positioning Satellite Orbital Intersection Systems, and (5) sensors (Radar, LIDAR, Video), forming situational awareness. In such an example, each such numerical result is tabulated into Zadeh-Freeman Fuzzy Membership Functions (FMF); altogether there are five FMFs in this example. Moreover, there are (6) man-man and man-machine interface cardinal rules “thou shall do no harm to others” to single out the right of pedestrians and law enforcement agencies in their own reference frame, even though they might appear at the moment of DAV to violate the traffic signs and controls. The machine must realize those traffic signs serve to humans merely not as the cardinal rules but as a reference and recommendation only.

Thus, we must train the 3^{rd} Gen AI to accept open sets of all dynamic variables with all possible occurrence frequency in a triangular shape function with respect to the numerical values. These frequency functions are called by Lotfi Zadeh and Walter Freeman of UC Berkeley as Fuzzy Membership Functions (FMFs). The 3rd Gen AI must understand human fuzzy logic thinking with FMFs.

Human fuzzy thinking in a linguistic sense can encompass attributes that are indefinite, such as “young” and “beauty” which are ill-defined and subjective and therefore open sets of possibility tabulated in the FMFs. They cannot be normalized as a unit probability, but open set possibilities are powerful aspects of human thinking. However, when Boolean logic “union & intersection” is applied, these FMFs becomes much sharper in a way that all humans understand. For example, when applied to the young FMF and the beautiful FMF, the resulting young and beautiful is clear to humans, and the new AI machine must comprehend.

Thus, scientists and automation engineers and computer technologists must understand the simple fact that general automation technology (not on Mars or in no man's land, such as the desert) must deal with human society in order to co-exist peacefully with humans. The challenge of human society is that not only logical thinking but also emotional feeling are all analog in nature, not digitally binary. Applying the multiple FMF approach to simulation data can provide the missing piece that can shorten the timeline to realize sensible DAV results from the projected 13 years to likely half that time, without violation of the Cardinal rule “Thou shall do no harm to humans”. Then the Boolean logic applied to a decision such as the action to be performed at a red traffic light in a situation in which there is no other detected traffic, such as in a small desert town at midnight, the DAV might slow down and glide through the intersection, rather than stop at the red light. In certain situations, breaking a rule that is made to be broken is truly intelligence behavior.

Absent application of numerous inputs to an FMF, an impatient human driver might take over the control of DAV, and drive through the red light. The human visual system begins with deep convolutional learning feature extraction at the back of the head cortex 17 area: layer V1 for color extraction; V2, edge; V3, contour; V4, texture; V5-V6 etc. for scale-invariant feature extraction for survival of the species. Then, one can follow the classifier in the associative memory hippocampus called machine learning. The adjective “deep” refers to structured hierarchical learning with higher-level abstraction in multiple layers of Convolution Neural Networks (CNNs) of which each layer is equivalent to a cut in feature domain as a liner classifier to a broader class of machine learning to reduce the False Alarm Rate (FAR) which is further divided into False Positive Rate (FPR) and False Negative Rate (FNR). This is necessary: FAR=FPR+FNR, because of the nuisance False Positive Rate (FPR), and the harmful False Negative Rate, which is detrimental in that it could delay an early opportunity. Sometimes these “multiple layers” in the so-called “deep learning” will overfit in a subtle way, and become “brittle” outside the training set. (S. Ohlson: “Deep Learning: How the Mind Overrides Experience,” Cambridge Univ. Press 2006.). Thus, our Natural Intelligence (NI) based on the unsupervised deep learning BNN under thermodynamic equilibrium at Minimum Free Energy can determine an optimum architecture. This is similar to our life brain neural nets, the BNN can increasing/recruiting and pruning/trimming of other layer neurons for “dynamic self-architectures”. This is possible by the novel derivation of the unified formulae of six kinds of glia cells as a free energy gradient with respect to dendrite trees (Eqs. 1-13) that are non-conducting made of fatty acids and may have four forms in the central nervous system, and two forms in the peripheral nervous (spinal cord) system. The differences are six different dendrite tree structures. These 10 billions of neurons have housekeeping 100 billion of glia cells, for example, Astrocytes, that can clean up beta-Amyloid deposits among billions of synaptic junctions in the short term memory and long term memory Hippocampus during nighttime sleep (when no more energy byproduct is blocking the narrow corridor traffic) to prevent dementia Alzheimer disease (cf. Brain Drain, Scientific Am. 2017). These neurons and glia cells can glue together layer by layer or recruit or prune other neurons into the same layer or not.

The present invention is a consistent framework of computational intelligence with dynamic memory from which one can generalize supervised deep learning (SDL) based on a least mean squares (LMS) cost function, to unsupervised deep learning (UDL) based on Minimum Free Energy (MFE). The MFE is derived from the constant temperature brain in isothermal equilibrium based on Boltzmann entropy and Boltzmann irreversible heat death. Furthermore the house-keeping glia cells (Astrocytes) together with the neuron firing rate given five decades ago by biologist D. O. Hebb are derived from the principles of thermodynamics. The unsupervised deep learning of the present invention can be used to predict brain disorders by medical imaging processing for early diagnosis.

Leveraging the recent success of Internet giants such as Google, Alpha Go, Facebook, and YouTube, which have minimized LMS errors between desired outputs and actual outputs to train big data (check board positions, age-emotional faces, videos) analysis using multiple-layer (about 100) Artificial Neural Networks (ANN), the connection-weight matrix [W_{j,i}] between j-th and i-th processor elements (about millions per layer) has been recursively adapted as SDL. UDL has been developed based on Biological Neural Networks (BNN). Essentially, using parallel computing hardware such as GPU, and changing the software from ANN SDL to BNN UDL, both neurons and glial cells are operated at brain dynamics characterized by MFE ΔH_{brain}=ΔE_{brain}−TₒΔS_{brain}≤0. This is derived from the isothermal equilibrium of the brain at a constant temperature Tₒ. The inequality is due to the Boltzmann irreversible thermodynamics heat death ΔS_{brain}>0, due to incessant collision mixing increasing the degree of uniformity and increasing entropy without any other assumption. The Newtonian equation of motion of the weight matrix follows the Lyapunov monotonic convergence theorem. Reproducing the learning rule observed by neurophysiologist D. O. Hebb a half century ago leads to derivation of biological glia (In Greek: glue) cells

$$\begin{matrix}{g}_{k} ≡ - \frac{Δ {H}_{brain}}{Δ {Dentrite}_{k}} & ( 3 ) \\ {Dendrite}_{k} ≡ {\sum }_{i} [ {W}_{i , k} ] {\vec{S}}_{i} & ( 4 )\end{matrix}$$

as the glue stem cells become divergent, predicting brain tumor “glioma” in about 70% of brain tumors. Because one can analytically compute H_{brain} from an image pixel distribution, one can in principle predict or confirm the singularity ahead of time. Likewise, the other malfunction of other glial cells such as astrocytes that can no longer clean out energy byproducts, for example, Amyloids peptides, blocking the Glymphatic system can cause Alzheimer disease if near the frontal lobe for short-term memory loss, or the Hippocampus for long-term memory loss; if this happens near the cerebellum, the effect on motor control can lead to Parkinson-type trembling diseases.

As a conceptual example, consider the scenario of driverless car (autonomous vehicle or AV) in the critical scenario of stopping at a red light. According to the von-Neumann-Poincare Ergodicity Theorem, consider 1000 identical AVs equipped with identical full sensor suites for situation awareness. Current Artificial Intelligence (AI) can improve the Rule-Based Expert System (RBES), for example, “brake at red light rule,” to an Experience-Based Expert System, becoming “glide slowly through” under certain Cardinal Rule conditions.

To help AV decision making, all possible occurrences cannot be normalized as a close-set probability and therefore an open-set possibility must be used, including L. Zadeh & W. Freeman Fuzzy Membership Functions (FMFs), and the Global Position System (GPS at 100′ resolution) FMF, as well as the Cloud Big Database in the trinity: “Data, Product, User,” for example, billions of smartphones, in positive enhancement loops.

The machine can statistically generate all possible FMFs with different gliding distances of which the occurrence frequency peak around a triangle shape (with a mean and a variance). It is associated with different brake-stopping FMF distances for the 1000 cars to generate statistically Sensor Awareness FMF. Their Boolean Logic Union and Intersection helps the final decision-making system. The averaged behavior mimics the Wide-Sense irreversible “Older & Wiser” “Experience-Based Expert System (EBES)” improved from “Rule Based Expert System (RBES)”.

Closed set I/O neural net computing is more rigid than and less superior than open set I/O neural net computing.

Boltzmann Wide-Sense Ergodicity (BWE) is defined to be (wide-sense includes irreversible thermodynamics) output of the spatial ensemble average of a large number of machines in irreversible thermodynamics becomes a closer approximation to that of a single long-live older and wiser machine. Boltzmann “Wide-Sense Stationary” Principle: irreversible thermodynamics (Definition: Delta S>0)—time averaging implies getting “older and wiser” (if assuming lifelong learning). While time tₒ can be arbitrarily chosen to be time-averaged over the time duration T, say the duty cycle in a year, the space xₒ is likewise arbitrarily chosen to be space-averaged over the thousand-machine identical open set of the ensemble (weighted by the irreversibly increasing of the Entropy (ΔS_{Boltzmann}>0) due to incessant collision mixing uniformity), governed by Maxwell-Boltzmann Canonical Ensemble denoted by the angular brackets subscripted by P(H(xₒ)) indicating at Minimum (Helmholtz) Free Energy (MFE).

D̅a̅t̅a̅(̅x̅ₒ̅+̅x̅′̅;̅t̅ₒ̅+̅t̅)̅D̅a̅t̅a̅(̅x̅ₒ̅+̅x̅′̅;̅t̅ₒ̅+̅t̅)̅^̅{̅t̅}̅^̅{̅ₒ̅}̅^{T}≅<Data(xₒ+x′;tₒ+t)Data(xₒ+x′;tₒ+t)>p₍ₓ_{ₒ}₎ (5)

An AI machine has a limited life span or duty cycle and cannot gain the older and wiser experience naturally. Nonetheless, BME identical Massive Parallel Distributed (MPD) hardware matching with MPD software (like hands wearing matching gloves) generates multiple-layer fast and efficient neural net computing and sharing open set of I/O big data bases in the Cloud.

As a result, the classical AI ANN (that maps closed set of inputs to closed set of outputs (closed I/O)) can be generalized in the normalized probability used for the time-average Rule-Based Expert System (RBES), for example, a driverless car or autonomous vehicle (AV) must “stop at a red light”.

The modern NI BNN (which maps an open set of inputs to an open set of outputs (open I/O)) with thousands of identical irreversible thermodynamic systems satisfying the Boltzmann Wide-Sense Ergodicity Principle (WSEP) that can capture the open set of possibility representation results in this example in four Fuzzy Membership Functions (FMFs), which are (a) Stopping (brake control) FMF, (b) Collision (avoidance RF & EOIR sensor situation awareness) FMF, (c) Global Position System FMF (at 100′ resolution), the Boolean logic (intersect and union) (d) Sensor Awareness FMF of which generates a sharper Experience-Based Expert System (EBES) that will “glide through a red light in the desert at midnight.”

Maxwell-Boltzmann Probability: P(xₒ)=exp(−H_{brain}(xₒ)/k_{B}T), (6)

min. H_{brain}(xₒ)↓E(xₒ)−TS(xₒ)↑ (7)

Control steering wheel Lyaponov convergence of learning of

$$\frac{{dH}_{brain}}{dt} = \frac{\partial {H}_{brain}}{\partial [ W ]} \frac{d [ W ]}{dt} = \frac{\partial {H}_{brain}}{\partial [ W ]} ( - \frac{\partial {H}_{brain}}{\partial [ W ]} ) = - {( \frac{\partial {H}_{brain}}{\partial [ W ]} )}^{2} \leq 0 \qquad ( 8 )$$

Langevin equation of the car momentum [symbol] = [symbol] , with tire-road friction coefficient f, car-body aerodynamic fluctuation force [symbol] (t):

For example, we consider the Einstein Brownian equation of motion, e.g. Langevin friction equation of motion of Einstein fluctuation and dissipation theorem with fluctuation forces denoted with the tilde with Dirac-delta point correlation for all different initial and boundary conditions.

$$\begin{matrix}m \frac{dV}{dt} = - fV + \tilde{F} ( t ) ; & ( 9 a ) \\ < \tilde{F} ( t ) \tilde{F} ( {t}^{′} ) >= {k}_{B} T \frac{f}{m} δ ( t - {t}^{′} ) & ( 9 b )\end{matrix}$$

Each follows asynchronously its own clock time in Newton-like dynamics at its own time frame

“tⱼ=εⱼt”;εⱼ≥1 time causality

with respect to its own initial boundary conditions with respect to the global clock time “t”

$$\frac{d [ {W}_{i , j} ]}{{dt}_{j}} = - \frac{\partial {H}_{brain}}{\partial [ {W}_{i , j} ]} ; \qquad ( 10 )$$

Proof: The overall system is that force changing synaptic 1^{st} order Hebb rule as the acceleration which is convergent guaranteed by a quadratic A. M. Lyaponov function:

$$\frac{{dH}_{brain}}{dt} = {\sum }_{j} \frac{\partial {H}_{brain}}{\partial [ {W}_{i , j} ]} {ɛ}_{j} \frac{d [ {W}_{i , j} ]}{{dt}_{j}} = - {\sum }_{j} {ɛ}_{j} {\vert \frac{\partial {H}_{brain}}{\partial [ {W}_{i , j} ]} \vert}^{2} \leq 0 ; \\ {ɛ}_{j} \geq 0 time causality . \\ Δ [ {W}_{i , j} ] = \frac{\partial [ {W}_{i , j} ]}{\partial {t}_{j}} η = - \frac{\partial {H}_{brain}}{\partial [ {W}_{i , j} ]} η = - \frac{\partial {H}_{brain}}{Δ {\vec{D}}_{j}} \cdot ( \frac{\partial {\vec{D}}_{j}}{\partial [ {W}_{i , j} ]} ) η ≡ {\vec{g}}_{j} {\vec{S}}_{i} η \qquad ( 11 )$$

This Hebb Learning Rule may be extended by chain rule for multiple layer “Backprop algorithm” among neurons & glial cells

[W_{i,j}]=[W_{i,j}]^{old}+ [symbol] η (12)

where the differential chain rule can reproduce the unsupervised Backward Propagation Algorithm

$${\vec{g}}_{j} ≡ - \frac{\partial {H}_{brain}}{\partial {\vec{Dentrite}}_{j}} = {\sum }_{k} ( - \frac{\partial {H}_{brain}}{\partial \vec{{S}_{j}^{′}}} ) \cdot \frac{\partial \vec{{S}_{j}^{′}}}{\partial {\vec{Dentrite}}_{j}} = \frac{\partial \vec{{S}_{j}^{′}}}{\partial {\vec{Dentrite}}_{j}} {\sum }_{k} ( - \frac{\partial {H}_{brain}}{\partial {\vec{Dentrite}}_{k}} ) \frac{\partial }{\partial \vec{{S}_{i}^{′}}} {\sum }_{i} [ {W}_{k , i} ] \vec{{S}_{i}^{′}} = \vec{{S}_{j}^{′}} ( 1 - \vec{{S}_{j}^{′}} ) {\sum }_{k} \vec{{g}_{k}} [ {W}_{k , j} ] \qquad ( 13 )$$

All these dynamic equations produce for different initial and boundary conditions occurrence frequency FMFs. Their Boolean Union and Intersection Logic generate the final decision. For example, see FIG. 11:

Brake Steering FMF∩Sensor Awareness FMF∩GPS space time∩Tire_{weight location}FMF=smart stop σ(stop distance)

A Fuzzy Membership Function is an open set and cannot be normalized as the probability but instead as a possibility. Boolean logic, namely the union and intersection, is sharp, not fuzzy. “Fuzzy Logic” is a misnomer. Logic cannot be fuzzy, but the set can be an open possibility. Thus, an RBES becomes flexible as EBES and replacing RBES with EBES is a natural improvement of AI.

According to an aspect of the invention, an experience-based expert system includes an open-set neural net computing sub-system, which includes massive parallel distributed hardware configured to process associated massive parallel distributed software configured as a natural intelligence biological neural network that maps an open set of inputs to an open set of outputs.

The neural net computing sub-system can be configured to process data according to the Boltzmann Wide-Sense Ergodicity Principle. The neural net computing sub-system can be configured to process input data received on the open set of inputs to determine an open set of possibility representations and to generate a plurality of fuzzy membership functions based on the representations. The neural net computing sub-system can be configured to generate output data based on the fuzzy membership functions and to provide the output data at the open set of outputs. The system can also include an external intelligent system coupled for communication with the neural net computing sub-system to receive the output data and to make a decision based at least in part on the received output data. The external intelligent system can include an autonomous vehicle. The decision can determine a speed of the autonomous vehicle, or whether to stop the autonomous vehicle.

The system can also include inputs configured to receive global positioning system data and cloud database data. The neural net computing sub-system can be configured to perform a Boolean algebra average of the union and intersection of the fuzzy membership functions, the global positioning system data, and the cloud database data.

According to another aspect of the invention, a method of mapping an open set of inputs to an open set of outputs includes providing an open-set neural net computing sub-system having massive parallel distributed hardware, and configuring the open-set neural net computing sub-system to process associated massive parallel distributed software configured as a natural intelligence biological neural network.

The can also include configuring the neural net computing sub-system to process data according to the Boltzmann Wide-Sense Ergodicity Principle. The method can also include configuring the neural net computing sub-system to process input data received on the open set of inputs to determine an open set of possibility representations and to generate a plurality of fuzzy membership functions based on the representations. The method can also include configuring the neural net computing sub-system to generate output data based on the fuzzy membership functions and to provide the output data at the open set of outputs. The method can also include coupling an external intelligent system for communication with the neural net computing sub-system to receive the output data and to make a decision based at least in part on the received output data. The external intelligent system can include an autonomous vehicle. The decision can determine a speed of the autonomous vehicle or whether to stop the autonomous vehicle.

The method can also include configuring inputs to receive global positioning system data and cloud database data. The method can also include configuring the neural net computing sub-system to perform a Boolean algebra average of the union and intersection of the fuzzy membership functions, the global positioning system data, and the cloud database data.

### BRIEF DESCRIPTION OF THE DRAWINGS

FIG. 1 is an exemplary ambiguous figure for use in human target recognition.

FIG. 2 shows (a) a single layer of an Artificial Neural Network expressed as a linear classifier and (b) multiple layers of an ANN.

FIG. 3 is an exemplary representation of a neuron with associated glial cells.

FIG. 4 is an exemplary illustration of six types of glial cells.

FIG. 5 is a simple graph of a Fuzzy Membership Function.

FIG. 6 shows the Boolean algebra of the Union and the Intersection for the Fuzzy Membership function of the driverless car example.

FIG. 7 illustrates the nonlinear threshold logic of activation firing rates (a) for the output classifier and (b) hidden layers hyperbolic tangent.

FIG. 8 illustrates an example of associative memory.

FIG. 9 shows diagrams related to epileptic seizures.

FIG. 10 is a graph of the nonconvex energy landscape.

FIG. 11 is an exemplary diagram showing dynamic equations producing occurrence frequency FMFs for different initial and boundary conditions.

FIG. 12 is a graph showing the standard sigmoid threshold logic derived from two-state normalization of the Maxwell-Boltzmann distribution function.

FIG. 13 is a graph showing piecewise negative N-shaped sigmoid logic.

FIG. 14 is an illustration of a neuron.

FIG. 15 is a Michel Feigenbaum bifurcation logistic map.

### DETAILED DESCRIPTION OF THE INVENTION

The invention leverages the recent success of Big Data Analyses (BDA) by the Internet Industrial Consortium. For example, Google co-founder Sergey Brin, who sponsored AI AlphaGo, was surprised by the intuition, the beauty, and the communication skills displayed by AlphaGo. The Google Brain AlphaGo Avatar beat Korean grandmaster Lee SeDol in the Chinese game Go in 4:1 as millions watched in real time Sunday Mar. 13, 2016 on the World Wide Web. This accomplishment surpassed the WWII Alan Turing definition of AI, that is, that an observer cannot tell whether the counterpart is human or machine. Now six decades later, the counterpart can beat a human. Likewise, Facebook has trained 3-D color block image recognition, and will eventually provide age and emotion-independent face recognition capability of up to 97% accuracy. YouTube will automatically produce summaries about all the videos published by YouTube, and Andrew Ng at Baidu surprisingly discovered that the favorite pet of mankind is the cat, not the dog! Such speech pattern recognition capability of BDA by Baidu utilizes massively parallel and distributed computing based on classical ANN with SDL called Deep Speech and outperforms HMMs.

Potential application areas are numerous. For example, the biomedical industry can apply ANN and SDL to profitable BDA areas, such as Data Mining (DM) in Drug Discovery, for example, Merck Anti-Programming Death for Cancer Typing beyond the current protocol (2 mg/kg of BW with IV injection), as well as the NIH Human Genome Program, and the EU Human Epi-genome Program. SDL and ANN can be applied to enhance Augmented Reality (AR), Virtual Reality (VR), and the like for training purposes. BDA in law and order societal affairs, for example, flaws in banking stock markets, and law enforcement agencies, police and military forces, may someday require use of “chess-playing proactive anticipation intelligence” to thwart the perpetrators or to spot the adversary in a “See-No-See” Simulation and Modeling, in man-made situations, for example inside-traders; or in natural environments, for example, weather and turbulence conditions. Some of them may require a theory of UDL as disclosed herein.

Looking deeper into the deep learning technologies, these are more than just software, as ANN and SDL tools have been with us over three decades, and since 1988 have been developed concurrently by Werbos, Paul John (“Beyond Regression: New Tools for Prediction and Analysis in the Behavioral Sciences” Harvard Univ. 1974), McClelland and Rumelhart (“Parallel Distributed Processing”, MIT Press, 1986). Notably, Geoffrey Hinton and his protegees, Andrew Ng, Yann LeCun, Yoshua Bengio, George Dahl, et al. (cf. Deep Learning, Nature, 2015), have participated in major IT as scientists and engineers programming on Massively Parallel Supercomputers such as Graphic Processor Units (GPU). A GPU has eight CPUs per rack and 8×8=64 racks per noisy air-cooled room, at a total cost of millions of dollars. Thus, toward UDL, we program on a mini-supercomputer and then program on the GPU hardware and change the ANN software SDL to BNN “wetware,” since the brain is 3-D carbon-computing, rather 2-D silicon-computing, and therefore involves more than 70% water substance.

Historically speaking, when Albert Einstein passed away in 1950, biologists wondered what made him smart and kept his head for decades for subsequent investigation. They were surprised to find that his head weighed about the same as an average human head at 3 pounds, and by firing rate conductance measurement determined that he had the same number of neurons as an average person, about ten billion. These facts suggested the hunt remains for the “missing half of Einstein's brain.” Due to the advent of brain imaging (f-MRI based on hemodynamics (based on oxygen utility of red blood cells to be ferromagnetic vs. diamagnetic he combined with oxygen), CT based on micro-calcification of dead cells, PET based on radioactive positron agents), neurobiology discovered the missing half of Einstein's brain to be the non-conducting glial cells (cells made mostly of fatty acids), which are smaller in size than about 1/10^{th} of a neuron, but which perform all the work except communication with ion-firing rates. Now we know that a brain takes two to tango: “billions of neurons (gray matter) and hundreds of billions of glials (white matter).” The traditional approach of SDL is solely based on neurons as Processor Elements (PE) of ANN, overlooking the name recognition. Instead of SDL training cost function, the LMS garbage-in and garbage-out, using LMS Error Energy,

E=|(desired Output [symbol] ₚₐᵢᵣₛ−actural Output Ŝₚₐᵢᵣₛ(t)|² (14)

sensory unknown inputs,

Power of Pairs:

[symbol]

ₚₐᵢᵣₛ(t)=[Aᵢⱼ] [symbol] ₚₐᵢᵣₛ(t) (15)

and the agreed signals form the vector pair time series [symbol] ₚₐᵢᵣₛ(t) with the internal representation of degree of uniformity of the neuron firing rate [symbol] ₚₐᵢᵣₛ(t) described with Ludwig Boltzmann entropy with unknown space-variant impulse response functions mixing matrix [Aᵢⱼ] and the inverse by learning synaptic weight matrix.

Convolution Neural Networks: Ŝₚₐᵢᵣₛ(t)=[Wⱼᵢ(t)] [symbol] ₚₐᵢᵣₛ(t) (16)

The unknown environmental mixing matrix is denoted[Aᵢⱼ]. The inverse is the Convolutional Neural Network weight matrix [Wⱼᵢ] that generates the internal knowledge representation.

The unique and the only assumption, which is similar to early Hinton's Boltzmann Machine, is the measure of degree of uniformity, known as the Entropy, introduced first by Ludwig Boltzmann in Maxwell-Boltzmann Phase Space Volume Probability W_{MB}. The logarithm of the probability is a measure of degree of uniformity called in physics as the total Entropy, Sₜₒₜ

Total Entropy: Sₜₒₜ=k_{B} Log W_{MB} (17a)

Solving Eq. (17a) for the phase space volume W_{MB}, we derive the Maxwell-Boltzmann (MB) canonical probability for an isothermal system:

$${W}_{MB} = exp ( \frac{{S}_{tot}}{{k}_{B}} ) = exp ( \frac{( {S}_{brain} + {S}_{env .} ) {T}_{o}}{{k}_{B} {T}_{o}} ) = exp ( \frac{{S}_{brain} {T}_{o} - {E}_{brain}}{{k}_{B} {T}_{o}} ) = exp ( - \frac{{H}_{brain}}{{k}_{B} {T}_{o}} ) \qquad ( 17 b )$$

Use is made of the isothermal equilibrium of the brain in the heat reservoir at the homeostasis temperature Tₒ. Use is further made of the second law of conservation of energy ΔQ_{env.}=TₒΔS_{env.} and the internal brain energy. ΔE_{brain}+ΔQ_{env.}=0, and then we integrate the change and drop the integration constant due to arbitrary probability normalization. Because there are numerous neuron firing rates, the scalar entropy becomes a vector entropy for the internal representation of vector clusters of firing rates.

{Sⱼ}→ [symbol] (18)

Biological Natural Intelligence (NI) UDL on BNN is applied, which is derived from the first principle, isothermal brain at Helmholtz Minimum Free Energy (MFE). Then from convergence theory, and the D. O. Hebb learning rule, we derive for the first time the mathematical definition of what historians called the “missing half of Einstein's brain,” namely glial cells as MFE glue forces. In other words, rather than simply “Me-Too” copycat, it is preferable to go beyond the AI ANN with Supervised Learning LMS Cost Function and Backward Error Propagation-Algorithm, and to consider NI BNN Unsupervised Learning MFE Cost Function and Backward MFE Propagation.

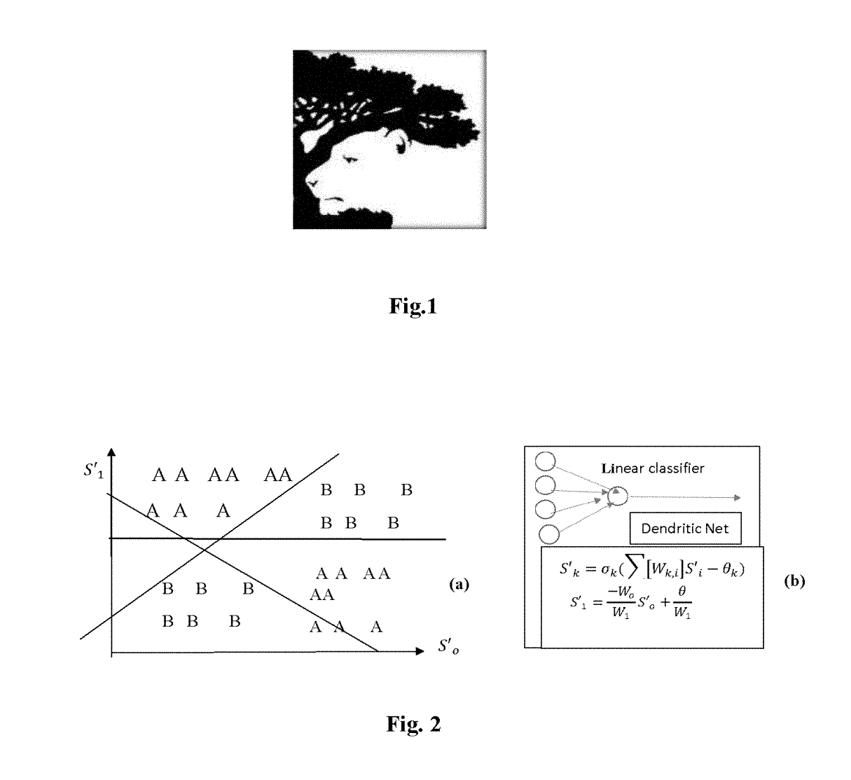

Referring to FIG. 1, NI human target recognition must be able separate a binary figure and ground at dusk under dim lighting from far away. This could be any simple ambiguity figure for computational simplicity. The idea of NI in BNN for survival is manifested in “ [symbol] =Tigress” and ground “ [symbol] =Tree”. In contrast, the supervised cost function LMS AI based on ANN becomes ambiguity of binary figure and ground Least Mean Squares (LMS) cost function |( [symbol] − [symbol] )²|=|( [symbol] − [symbol] )²| could not separate to run away for the survival of the species due to the switch of the algebra sign. However, higher orders of moment expansion of MFE can separate the tiger and tree in the remote dim light for the survival of Homosapiens.

We begin with traditional signal processing of the so-called recursive-average Kalman filtering. We generalize the Kalman filtering with “learnable recursive average” called the single layer of ANN, Kohonen Self Organization Map (SOM), or Carpeter-Grossberg “follow the leader” Adaptive Resonance Theory (ART) model. This math is known from early recursive signal processing. The new development is threshold logic at each processing element's (PE) so-called neurons.

$$\begin{matrix} {\overline{x}}^{N} ≡ \frac{1}{N} {\sum }_{i = 1}^{N} {x}_{i} < x {>}_{N} = \frac{1}{\sum {w}_{i}} {\sum }_{i = 1}^{N} {w}_{i} {x}_{i} ; & ( 19 ) \\ {\overline{x}}^{N + 1} ≡ \frac{1}{N + 1} {\sum }_{i = 1}^{N + 1} {x}_{i} = \frac{N + 1 - 1}{N + 1} \frac{1}{N} {\sum }_{i = 1}^{N} {x}_{i} + \frac{1}{N + 1} {x}_{N + 1} = {\overline{x}}^{N} + \frac{1}{N + 1} ( {x}_{N + 1} - {\overline{x}}^{N} ) & ( 20 ) \\ < x {>}_{N + 1} = < x {>}_{N} + K ( {x}_{N + 1} - < x {>}_{N} ) , & ( 21 )\end{matrix}$$

where K represents a Kalman gain filtering of the single-stage delta that may be minimized from a cost function, such as an LMS criterion. However, the reason the classifier ANN requires multiple layers of PE neurons, as the so-called Deep Learning.

Referring to FIG. 2, ANNs need multiple layers known as “Deep Learning”. FIG. 2(a) shows that while a single layer of ANN can simply be a linear classifier shown in FIG. 2(b), multiple layers can improve the False Alarm Rate denoted by symbol “A” included in the second class “B”. Obviously, it will take three linear classifier layers to completely separate both the mixed classes A and B.

### Theory Approach

NI is based on two necessary and sufficient principles observed from the common physiology of all animal brains (Szu et al., circa 1990):
(i) Homeostasis Thermodynamic Principle: all animals roaming on the Earth have isothermal brains operating at a constant temperature Tₒ (Homosapiens 37° C. for the optimum elasticity of hemoglobin, chickens 40° C. for hatching eggs).
(ii) Power of Sensor Pairs principle: All isothermal brains have pairs of input sensors [symbol] ₚₐᵢᵣₛ for the co-incidence account to de-noise: “agreed, signal; disagreed, noise,” for instantaneously signal filtering processing.

Thermodynamics governs the total entropy production ΔSₜₒₜ of the brain and its environment that leads to irreversible heat death, due to the never-vanishing Kelvin temperature (the 3^{rd} law of thermodynamics) there is an incessant collision mixing toward more uniformity and larger entropy value.

ΔSₜₒₜ>0 (22)

We can assert the brain NI learning rule

ΔH_{brain}=ΔE_{brain}−TₒΔS_{brain}≤0 (23)

This is the NI cost function at MFE useful in the most intuitive decision for Aided Target Recognition (AiTR) at Maximum PD and Minimum FNR for Darwinian natural selection survival reasons.

The survival NI is intuitively simple, flight or fight, parasympathetic nerve system as an auto-pilot.

Maxwell-Boltzmann equilibrium probability is derived early in (17b) in terms of the exponential weighted Helmholtz Free Energy of the brain:

H_{brain}=E_{brain}−TₒS_{brain}+const. (24)

of which the sigmoid logic follows as the two states of BNN (growing new neuron recruits or trim prune old neurons) probability normalization dropping the integration constant:

$$exp ( - \frac{{H}_{recruit}}{{k}_{B} {T}_{o}} ) / exp ( - \frac{{H}_{prune}}{{k}_{B} {T}_{o}} ) + exp ( - \frac{{H}_{recruit}}{{k}_{B} {T}_{o}} ) = 1 / [ exp ( Δ H ) + 1 ] = σ ( Δ H ) = \{ \begin{matrix}1 , Δ H \to ∞ \\ 0 , Δ H \to - ∞\end{matrix} \\ dimensionless Δ H = {H}_{recruit} - {H}_{prune} Q . E . D \qquad ( 25 )$$

Note that Russian Mathematician G. Cybenko has proved “Approximation by Superposition of a Sigmoidal Functions,” Math. Control Signals Sys. (1989) 2: 303-314. Similarly, A. N. Kolmogorov, “On the representation of continuous functions of many variables by superposition of continuous function of one variable and addition,” Dokl. Akad. Nauk, SSSR, 114(1957), 953-956.

Derivation of the Newtonian equation of motion the BNN from the Lyaponov monotonic convergence as follows: Since we know ΔH_{brain}≤0

Lyaponov:

$$\frac{Δ {H}_{brain}}{Δ t} = ( \frac{Δ {H}_{brain}}{Δ [ {W}_{i , j} ]} ) \frac{Δ [ {W}_{i , j} ]}{Δ t} = - \frac{Δ [ {W}_{i , j} ]}{Δ t} \frac{Δ [ {W}_{i , j} ]}{Δ t} = - {( \frac{Δ [ {W}_{i , j} ]}{Δ t} )}^{2} \leq 0 Q . E . D \qquad ( 26 )$$

Therefore, the Newtonian equation of motion for the learning of synaptic weight matrix follows from the brain equilibrium at MFE in the isothermal Helmholtz sense

Newton:

$$\frac{Δ [ {W}_{i , j} ]}{Δ t} = - \frac{Δ {H}_{brain}}{Δ [ {W}_{i , j} ]} \qquad ( 27 )$$

It takes two to tango. Unsupervised Learning becomes possible because BNN has both neurons as threshold logic and housekeeping glial cells as input and output.

We assume for the sake of causality that the layers are hidden from outside direct input, except the 1^{st} layer, and the l-th layer can flow forward to the layer l+1, or backward, to l−1 layer, etc.

We define the Dendrite Sum from all the firing rate [symbol] ᵢ lower input layer represented by the output degree of uniformity entropy [symbol] ᵢ as the following net Dendrite vector:

[symbol]

≡Σᵢ[W_{i,j}] [symbol] ᵢ (28)

We can obtain the learning rule observed the co-firing of the presynaptic activity and the post-synaptic activity by Neurophysiologist D.O. Hebb half century ago, namely the product between the presynaptic glial input [symbol] ⱼ and the postsynaptic output firing rate [symbol] ᵢ we proved it directly as follows:

Glial:

$$\frac{Δ [ {W}_{i , j} ]}{Δ t} = ( - \frac{Δ {H}_{brain}}{Δ {\vec{Dendrite}}_{j}} ) \frac{Δ {\vec{Dendrite}}_{j}}{Δ [ {W}_{i , j} ]} \approx {\vec{g}}_{j} {{\vec{S}}^{′}}_{i} , \qquad ( 29 )$$

Similar to the recursive Kalman filter, we obtain the BNN learning update rule (η≈Δt):

Δ[W_{i,j}]=[W_{i,j}(t+1)]−[W_{i,j}(t)]= [symbol] ⱼ [symbol] ᵢη (30)

Remarks about Glial Cell Biology

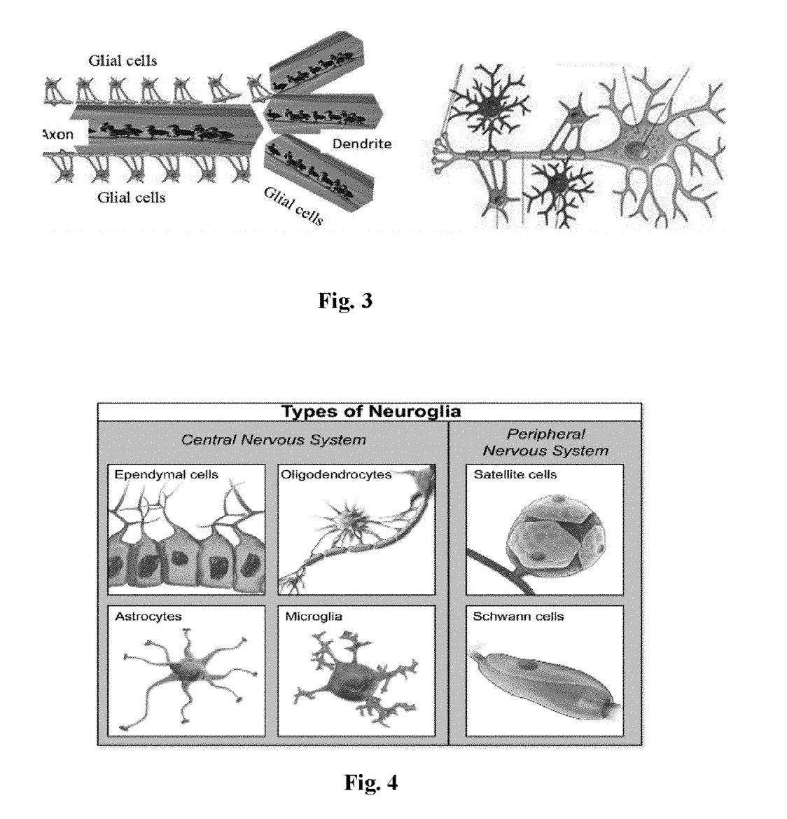

Glial cells are fatty acid white matter in the brain that surround each axon output pipe to insulate the tube as a co-axial tube. How can slow thermal positive charge large ions that repel one another transmit along an axon cable? Because in the coaxial cable, the axon is surrounded by the insulating fatty acid glial cells, which act as a modulator. It looks like “ducks line up across the road, one enters the road, and the other crosses over”. One ion pops in, the other ion pops out in pseudo-real time. The longest axon extends from the end of the spinal cord to the big toe, which we can nevertheless control in real time when running away from hunting lions. See FIG. 3.

Calcium ions are mutually repulsive. In order to understand this phenomenon, we introduce baby ducks that are naughty and repulsive like calcium ions; but when lined up in a narrow row restricted by the feet of neuroglia cells as the second tube outside of both arteries and veins, have no place to go but follow the front mother duck while pushed in the neuron cell by papa duck. While one in the other one out in real time.

This is how our brain performs in the longest nerve system from head to toe. Note that these neuroglia feet surrounding the blood vessels as the outer shell pass neural fluid in between to clean out debris during sleep. It is conjectured that the second channel property might be missing from dinosaurs, and that's why they evolved a second brain near the tail to walk and fight.

The missing half of Einstein's brain is the 100 B glial cells, which surround each axon as the white matter (fatty acids) that allows slow neuron to transmit ions fast. The more glial cells Einstein has, the faster neuron communication can take place in Einstein's brain. Thus, if one can quickly explore all possible solutions, one will be less likely to make a stupid decision.

Referring to FIG. 4, there are six kinds of glial cells (about one tenth the size of neurons; four kinds in the central nervous system, two in the spinal cord). They are more house-keeping servant cells than silent partners.

Functionality of glial cells: They surround each neuron axon output, in order to keep the slow neural transmit ions lined up inside the axon tube, so that one pushes in while the other pushes out in real time. There are more types of functionality as there are more kinds of glial cells.

This definition of glial cells seems to be correct, because the brain tumor “glioma,” the denominator of dendrite sum which has a potential singularity by division of zero if the MFE of the brain is not correspondingly reduced. This singularity turns out to be pathological as consistent with the medically known brain tumor “glioma.” The majority of brain tumors belong to this class of too-strong glue force. Notably, former President Jimmy Carter suffered from glioma, having three golf-ball sized large tumors. Nevertheless, immunotherapeutic treatment using the newly marketed Phase-4 monoclonal antibody presenter drug (Protocol: 2 mg per kg body weight IV injection) that identifies malignant cells and tags them for their own anti-body to swallow the malignant cells made by Merck Inc. (NJ, USA) as Anti-Programming Death Drug-1 Keytruda (Pembrolizumab). Mr. Carter recovered in three weeks but took six months to recuperate his immune system (August 2015-February 2016).

The human brain weighs about three pounds and is made of gray matter, neurons, and white matter, fatty acid glial cells. Our brain consumes 20% of our body energy. As a result, there are many pounds of biological energy by-products, for example, beta Amyloids. In our brain, billions of astrocytes glial cells are servant cells to the billions of neurons that are responsible for cleaning dead cells and energy production ruminants from those narrow corridors called brain blood barriers as the glymphatic system. This phenomena was discovered recently by M. Nedergaad and S. Goldman (“Brain Drain Sci. Am. March 2016”). They have discovered a good quality sleep about 8 hours, or else, the professionals and seniors with sleep deficiency will suffer slow death dementia, such as Alzheimer (blockage at LTM at Hippocampus or STM at Frontal Lobe) or Parkinson's (blockage at Motor Control Cerebellum).

BNN Deep Learning Algorithm: If the node j is a hidden node, then the glial cells pass the MFE credit backward by the chain rule

$${\vec{g}}_{j} ≡ - \frac{\partial {H}_{brain}}{\partial {\vec{Dendrite}}_{j}} = {\sum }_{k} ( - \frac{\partial {H}_{brain}}{\partial {\vec{{S}^{′}}}_{j}} ) \cdot \frac{\partial {\vec{{S}^{′}}}_{j}}{\partial {\vec{Dentrite}}_{j}} = \frac{\partial {\vec{{S}^{′}}}_{j}}{\partial {\vec{Dentrite}}_{j}} {\sum }_{k} ( - \frac{\partial {H}_{brain}}{\partial {\vec{Dentrite}}_{k}} ) \frac{\partial }{\partial \vec{S} {′}_{j}} {\sum }_{i} [ {W}_{k , i} ] {\vec{S}}_{i}^{′} = {\vec{S}}_{j}^{′} ( 1 - {\vec{S}}_{j}^{′} ) {\sum }_{k} \vec{{g}_{k}} [ {W}_{k , j} ] \qquad ( 31 )$$

Use is made of the Riccati equation to derive the sigmoid window function from the slope of a logistic map of the output value 0≤ [symbol] ⱼ≤1:

$$\begin{matrix}\frac{\partial \vec{{S}_{j}^{′}}}{\partial {\vec{net}}_{j}} = \frac{d \vec{{σ}_{j}}}{d {\vec{net}}_{j}} = {\vec{σ}}_{j} ( 1 - {\vec{σ}}_{j} ) - {\vec{{S}^{′}}}_{j} ( 1 - {{\vec{S}}^{′}}_{j} ) & ( 32 ) \\ \frac{\partial {\vec{net}}_{k}}{\partial \vec{{S}_{j}^{′}}} = [ {W}_{k , j} ] & ( 33 )\end{matrix}$$

Consequently, unsupervised learning “Back-Prop” has BNN passed the “glue force,” than supervised learning “Back-Prop” has ANN passed the “change.” The former passes the credit, the latter passes the blame:

[symbol]

ⱼ= [symbol] ⱼ(1− [symbol] ⱼ)Σₖ [symbol] ₖ[W_{k,j}] (34)

Substituting (34) into (30) we obtain finally the overall iterative algorithm of unsupervised learning weight adjustment over time step t is driven by the Back-Prop of the MFE credits

[Wⱼᵢ(t+1)]=[Wⱼᵢ(t)]+η\vec{g}ⱼ [symbol] +αₘₒₘ[Wⱼᵢ(t)−[Wⱼᵢ(t−1)]], (35)

where we have followed Lipmann the extra momentum term to avoid the Mexican standoff ad hoc momentum αₘₒₘ to pass the local minimum.

This code can be found in the Math work Mathlab Code. The only difference is the following Rosetta stone between NI BNN and AI ANN Paul Werbos, James McCelland, David Rumelhart, PDP Group 1988 MIT Press. Notably deep learning led by Geoffrey Hinton,

$$\begin{matrix}NI Glial {g}_{i} = - \frac{Δ {H}_{brain}}{Δ {Dendrite}_{i}} ; AI delta {δ}_{i} = - \frac{Δ LMS}{Δ {Net}_{i}} & ( 36 a , b ) \\ {Dendrite}_{i} = {\sum }_{j} [ {W}_{i , j} ] {S}_{j} ; {Net}_{i} = {\sum }_{j} [ {W}_{ij} ] {O}_{j} & ( 37 a , b ) \\ {S}_{i} = σ ( {Dendrite}_{i} ) ; {O}_{i} = σ ( {Net}_{i} ) & ( 38 a , b )\end{matrix}$$

The deep learning supervised LMS “Back Prop” algorithm, we shall expand the MFE “Back-Prop” between the l-th layer to the next l+l−th layer at the collective fan-in j-th node:

Dendritic Sum: [symbol] = [symbol] ≡Σᵢ[W_{j,i}] [symbol] ;

The C⁺⁺ Code of “SDL “Back Prop” for automated annotation has been modified by Cliff Szu (Fan Pop Inc.) from the open source: https://www.tensorflow.org/. Furthermore, he found that using a GTX 1080 compared to a 36-core Xeon server, performance with CUDA enabled was 30× higher.

Architecture Learning: A single layer determines a single separation plane for two-class separation; two layers, two separation planes for four classes; three layers, three planes, a convex hull classifier, etc. Kolmogorov et al. have demonstrated that multiple layers of ANN can mathematically approximate a real positive function. Lipmann illustrated the difference between single layer, two layers, and three layers beside the input data in FIG. 14 of his succinct review of all known static architecture ANN: “Introduction to Computing with Neural Nets,” Richard Lipmann, IEEE ASSP Magazine April 1987. Likewise, we need multiple layers of Deep Learning to do convex hull classification.

While a supervised AiTR will pass the LMS blame backward, unsupervised Automatic Target Recognition (ATR) will pass the MFE credit backward to early layers. Also, the hidden layer Degree of Freedom (DoF) is understood for the AiTR viewpoint as the feature space DoF_{features}, for example, sizes, shapes, and colors. If we wish to extract to accomplish a sizes- and rotation-invariant data classification job, the optimum design of ANN architecture should match estimated features of DoF_{data}−DoF_{out nodes}≅DoF_{features}. To make that generalization goal possible, we need enough DoF_{input nodes} together with the hidden feature layers DoF_{features} than the output classes DoF_{out nodes}. For example, we can accommodate more classes to be separated from the input data set if we require a Beer Belly hidden layer morphology, with respect to an Hourly Glass hidden layer architecture.

We wish to embed a practical “use it or lose it” pruning logic and “traffic jam” recruit logic in terms two free energy Hₚᵣᵤₙₑ and H_{recruit} whose slope defines the glial cells. Thus, the functionality architecture could come from the large or small glial force that can decide either to prune or recruit the next neuron into a functional unit or not.

Data-driven architecture requires the analyticity of data input vector [symbol] _{k prune} terms of input field data [symbol] , and discrete entropy classes of objects.

H_{brain}=E_{brain}−TₒS=Eₒ+ [symbol] ·[W_{i,j}]( [symbol] −[Wⱼₖ] [symbol] ₚᵣᵤₙₑ)+k_{B}TₒΣSᵢ log Sᵢ+(λ₀−k_{B}Tₒ)(ΣSᵢ−1) (39)

This is MFE. The linear term can already tell the difference between the target lion versus the background tree, (0−1)≠(1−0) without suffering the LMS parity invariance: (0−1)²=(1−0)².

The Wide-Sense Ergodicity Principle (WSEP)-based Boltzmann irreversible thermodynamics that the Maxwell-Boltzmann Canonical probability P(xₒ) has been derived as follows:

The single computer time-average denoted by the sub-bar is equivalent to the ensemble average of thousands of computers denoted by angular brackets in both the mean and variance moments.

### Wide-Sense Ergodicity Principle (WSEP):

Mean: Data(xₒ+x;t₀+t)ₜₒ=<Data(xₒ+x;tₒ+t)>_{P(x}_{ₒ}₎

Variance: Data(xₒ+x;tₒ+t)Data(xₒ+x; t₀+t)ₜₒ=<Data(xₒ+x;tₒ+t)Data(xₒ+x;tₒ+t)>_{P(X}_{ₒ}₎

where the Boltzmann constant k_{B} and Kelvin Temperature T (as 300° K(=27° C.)=k_{B}T=1/40 eV).

Maxwell-Boltzmann Probability: P(xₒ)=exp(−H(xₒ)/k_{B}T),

H is the derived Helmholtz Free Energy (H(xₒ) defined as the internal energy E of the system in contact with a heat bath at the temperature T. The H(xₒ) must be the E(xₒ) subtracting the thermal entropy energy TS and the net becomes the free-to-do work energy which must kept to a minimum to be stable:

min. H(xₒ)=E(xₒ)−TS(xₒ)

The WSEP makes AI ANN Deep Learning powerful, because the temporal evolution average denoted by the underscore bar can be replaced by the wide-sense equivalent spatial ensemble average denoted by the angular brackets.

A machine can enjoy thousands of copies, which each explore with all possible different boundary conditions that become collectively the missing experiences of a single machine.

Thus, MIT Prof. Marvin Minsky introduced the Rule-Based Expert System (RBES) which has now become the Experience-Based Expert Systems (EBES) having the missing common sense. For example, a driverless car will stop at different “glide lengths” near a traffic red light according to RBES. However, according to EBES, the driverless car will glide slowly through the intersection at times when there is no detection from both sides of any incoming car headlights. The intrinsic assumption is the validity of the Wide Sense-Temporal Average (WSTA) with the Wide Sense-Spatial Average (WSSA) in the Maxwell-Boltzmann Probability ensemble, so the time t and x of those cases which happens in times of low activity are known.

Thus, a conceptual example is the scenario of a driverless car approaching a traffic light, equipped with a full sensor suite, for example, a collision avoidance system with all-weather W-band Radar or optical LIDAR, and video imaging. Current Artificial Intelligence (AI) can improve the “Rule-Based Expert System (RBES),” for example, the “brake at red light rule,” to an “Experience-Based Expert System,” which would result in gliding slowly through the intersection in situations of low detected activity, such as at midnight in the desert. To help with machine decision-making, several Fuzzy Membership Functions (FMFs) can be utilized, along with a Global Position System (GPS) and Cloud Databases. Letting the machine statistically create all possible FMFs with different gliding speeds associated with different stopping distances for 1000 identical cars to generate statistically a Sensor Collision Avoidance FMF in a triangle shape (with mean and variance) and Stopping Distance FMF as well as GPS FMS. The Union and Intersection Boolean Algebra result in the final decision-making system. The averaged behavior mimics the irreversible “Older and Wiser” system to become an “Experience-Based Expert System (EBES)”. The Massively Parallel Distributed (MPD) Architecture (for example, Graphic Processors 8×8×8 Units which have been furthermore miniaturized in a backplane by Nvidia Inc.) must match the MPD coding Algorithm, for example, Python Tensor Flow. Thus, there remains a set of N initial and boundary conditions that must causally correspond to the final set of N gradient results. (Causality: An Artificial Neural Network (ANN) takes from the initial boundary condition to reach a definite local minimum) (Analyticity: there is an analytic cost energy function of the landscape). Deep Learning (DL) adapts the connection weight matrix [W_{j,i}] between j-th and i-th processor elements (on the order of millions per layer) in multiple layers (about 10-100). Unsupervised Deep Learning (UDL) is based on Biological Neural Network (BNN) of both Neurons and Glial Cells, and therefore the Experience-Based Expert System can increase the trustworthiness, sophistication, and explain-ability of the AI (XAI).

The Least Mean Squares (LMS) errors Supervised Deep Learning (SDL) between desired outputs and actual outputs, is replaced with Unsupervised Deep Learning (UDL) in Maxwell-Boltzmann Probability (MBP) ensemble at the brain dynamics characterized by Minimum Free Energy (MFE) ΔH_{brain}=ΔE_{brain}−TₒΔS_{brain}≤0. Next, the Darwinian survival-driven Natural Intelligence (NI) itemized is adopted as follows. (i) Generalize the 1-to-1 SDL based on Least Mean Squares (LMS) cost function, to N-to-N Unsupervised Deep Learning (UDL) based on Minimum Free Energy (MFE). (ii) The MFE is derived from the constant temperature Tₒ brain at the isothermal equilibrium based on the Maxwell-Boltzmann (MB) entropy S=k_{B} Log W_{MB} and Boltzmann irreversible heat death ΔS>0. (iii) Derive from the principle of thermodynamics, the house-keeping Glial Cells together with Neurons firing rate learning given 5 decades ago by biologist Hebb. (iv) Use. UDL to diagnose brain disorders by brain imaging. This is derived from the isothermal equilibrium of brain at a constant temperature Tₒ. The inequality is due to Boltzmann irreversible thermodynamics heat death ΔS_{brain}>0, due to incessant collision mixing increasing the degree of uniformity, keep increasing the entropy without any other assumption. The Newtonian equation of motion of the weight matrix follows the Lyapunov monotonic convergence theorem. The Hebb Learning Rule is reproduced, consequently to derive biological Glial (In Greek: Glue) cells

$${g}_{k} = - \frac{Δ {H}_{brain}}{Δ {Dentritic}_{k}}$$

as the glue stem cells become divergent, predicting brain tumor “Glioma” about 70% of brain tumors. Because H_{brain} can be computed analytically from the image pixel distribution, the singularity can in principle be predicted or confirmed. Likewise, the other malfunction of other Glial cells, for example, Astrocytes, can no longer clean out the energy byproducts, for example, Amyloids Beta (Peptides), blocking the Glymphatic draining system. The property WSEP is broad and important, for example, brain drain in 6 pillar directions (exercise, food, sleep, social, thinking, stress), we can avoid “Dementia Alzheimer Disease (DAD)” (Szu and Moon, MJABB V2, 2018). If the plaque happens near the synaptic gaps we lose the Short Term memory (STM), if in the Hippocampus we lose LTM; if happens near the cerebellum motor control, this leads to the “Parkinson” diseases.

Albert Einstein once said that “Science has little, to do with the truth, but the consistency.” Thus, he further stressed to “make it as simple as possible, but not any simpler.” The Human Visual System begins with Deep Convolutional Learning Feature Extraction at the back of the head's Cortex 17 area: layer V1 for color extraction; V2, edge; V3, contour; V4, Texture; V5-V6 etc. for scale-invariant feature extraction for survival of the species. Then, we follow the classifier in the associative memory Hippocampus called Machine learning. The adjective Deep refers to structured hierarchical learning higher level abstraction multiple layers of convolution ANNs to a broader class of machine learning to reduce the False Alarm Rate. This is necessary because of the nuisance False Positive Rate (FPR); but the detrimental False Negative Rate (FNR) could delay an early opportunity. Sometime will be over-fitting in a subtle way, becomes “brittle” outside the training set. (S. Ohlson: “Deep Learning: How the Mind overrides Experience,” Cambridge Univ. Press 2006.).

Thus, Biological Neural Networks (BNN) require growing, recruiting, and pruning by trimming 10 billion Neurons and 100 billion Glial Cells for the self-architectures, house cleaning (by Astrocytes Glial Cells) that can prevent Dementia Alzheimer Disease (DAD). The DAD is the fifth major disorder among Diabetics type II, Heart Attack, Strokes, Cancers for aging WWII Baby Boomers (Szu and Moon, “How to avoid DAD?” MJABB V2, February 2018).

It is possible to leverage the recent success of Big Data Analyses (BDA) by the Internet Industrial Consortium. For example, Google co-founder Sergey Brin sponsored AI AlphaGo and was surprised by the intuition, the beauty, and the communication skills displayed by AlphaGo. As a matter of fact, the Google Brain AlphaGo Avatar beat Korean grandmaster Lee SeDol in the Chinese Go Game in 4:1 as millions watched in real time Sunday Mar. 13, 2016 on the World Wide Web. This accomplishment has surpassed the WWII Alan Turing definition of AI that cannot tell the other end whether is a human or a machine. Now six decades later, the other end can beat a human. Likewise, Facebook has trained 3-D color blocks image recognition, and will eventually provide an age- and emotional-independent face recognition of up to 97% accuracy. YouTube will produce summaries automatically regarding all the videos on YouTube, and Andrew Ng at Baidu discovered surprisingly that the favorite pet of mankind is the cat, not the dog! Such speech pattern recognition capability of BDA by Baidu has utilized massively parallel and distributed computing based on the classical Artificial Neural Networks (ANN) with Supervised Deep Learning (SDL) called Deep Speech, which outperforms HMMs.

As mentioned above, the “Rule-Based Expert System (RBES),” for example, “how to break red light stop rule,” is now improved as a result. Statistically averaging over all possible “gliding speeds associated with different stopping distances” for 1000 driverless cars, the averaged behavior mimics the “Older-Wiser” becoming “Experience-Based Expert System (EBES)”. The Massively Parallel Distributed (MPD) Architecture (for example, Graphic Processor 8×8×8 Units which have been furthermore miniaturized in a backplane by Nvidia Inc.) must match the MPD coding Algorithm, for example, Python Tensor Flow. Thus, there remains the set of N initial and boundary conditions that must causally correspond to the final set of N gradient results. The reason is due to different Fuzzy Membership Functions (FMF). One is the Stopping FMF for the stopping distances, which may vary at all red lights. The other is Collision FMF that extracts from the video imaging and collision avoidance radar/lidar inputs that may generate a different collision FMF. Their intersection among stopping FMF and Collision FMF allow the driverless car to glide safely in sigmoid logic past a red light when combined with GPU FMF during times of very low activity.

Stopping FMF∩Collision FMF∩GPU FMF=σ(gliding over) (40)

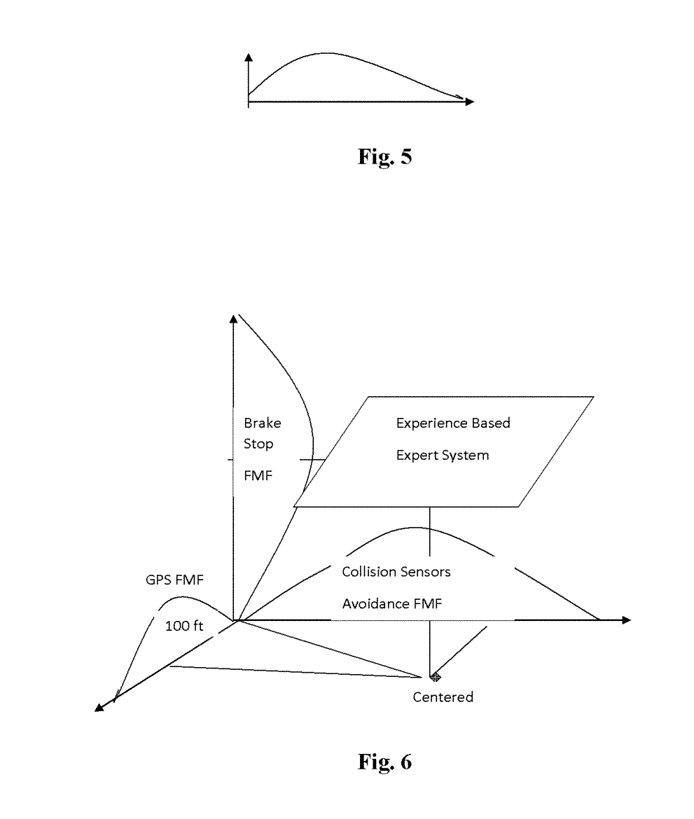

The Fuzzy Membership Function is an open set and cannot be normalized as a probability but instead as a possibility. See FIG. 5. For example, “young” is not well defined, 17 to 65 or 13 to 85. UC Berkeley Prof. Lotfi Zadeh invented Fuzzy Logic, but this is a misnomer in that the logic is not fuzzy, it is sharp Boolean logic, but the membership of an open set cannot be normalized as a probability, but rather as a possibility, which is “fuzzy”. Zadeh died at the age of 95 years old, so to him, 85 might have been young. That beauty is in the eye of beholder, is an open set. According to the Greek myth of Helen of Troy, beauty may be measured by how many ships will be sunk; a thousand ships might be sunk for the beauty of Helen, whereas only a hundred ships will be sunk for Eva. However, when the young FMF and the beautiful FMF are intersected together, we clearly know what the language of young and beautiful means. This is the utility of FMF.

The Boolean algebra of the Union ∪ and the Intersection ∩ is shown in FIG. 6 and is demonstrated in a driverless car, replacing a rule-based system with an experience-based expert system to glide through a red light at midnight in the desert without any possibility of collision (and any human/traffic police).

Consequently, the car will drive slowly through the intersection when the traffic light is red and there are no detected incoming cars. Such an RBES becomes flexible as an EBES, which is a natural improvement of AI.

Modern AI ANN computational intelligence wishes to apply by brute force using (1) a fast computer, (2) a smart algorithm, and (3) a large database, without several Fuzzy Membership Functions for the Experience-Based Expert System gained by thousands of identical systems in similar but different situations, in the control, command, communication information (C3I) decision made possible by “Fuzzy Logic.”—Boolean Logic among open sets FMF.

Exemplary collision Fuzzy Membership Function: Radar Collision Avoidance works for all-weather Radar operated at W band 99 GHz; Laser Radar (LIDAR) at optical bands as well as Video Image with box over target Processing. Brake Stopping FMF: The momentum is proportional to the car weight and car speed, which affects the stopping distances open set possibility FMF.

Global Position Satellites (Global positioning system (GPS) FMF: accuracy for the intersection of 4 synchronous, 1227.6 MHz (L2 band, 20 MHz wide) 1575.42 MHz (L1 band, 20 MHz wide). While the Up-link requires a high frequency to target the Satellite, the Down-link is at a lower frequency to hit cars circa 100 feet.

Consequently, the car will drive slowly through the red light intersection under certain conditions and when there are no detected incoming cars. Such an RBES becomes flexible as EBES, and replacing RBES with EBES is a natural improvement of AI.

We assume the Wide-Sense Ergodicity Principle (WSEP) defined as

1^{st} moment: D̅a̅t̅a̅(̅x̅ₒ̅+̅x̅;̅t̅ₒ̅+̅t̅)̅^̅{̅t̅}̅^̅{̅ₒ̅}̅≅<Data(xₒ+x;tₒ+t)>_{P(x}_{ₒ}₎ (41)

2^{nd} moment: D̅a̅t̅a̅(̅x̅ₒ̅+̅x̅′̅;̅t̅ₒ̅+̅t̅)̅D̅a̅t̅a̅(̅x̅ₒ̅+̅x̅′̅;̅t̅ₒ̅+̅t̅)̅^̅{̅t̅}̅^̅{̅ₒ̅}̅≅<Data(xₒ+x′;tₒ+t)Data(xₒ+x′;tₒ+t)>_{P(x}_{ₒ}₎ (42)

where the Boltzmann constant k_{B} and Kelvin Temperature T (as 300° K (=27° C.)=k_{B}T=1/40 eV).

Maxwell-Boltzmann Probability: P(xₒ)=exp(−H(xₒ)/k_{B}T), (43)

H is the derived Helmholtz Free Energy (H(xₒ)ₒ), defined as the internal energy E of the system in contact with a heat bath at the temperature T. The H(xₒ) must be the E(xₒ) subtracted the thermal entropy energy TS and the net becomes the free-to-do work energy which must kept to a minimum to be stable:

min. H(xₒ)=E(xₒ)−TS(xₒ) (44)

Other potential applications areas include the biomedical industry, which can apply ANN and SDL to these kinds of profitable BDA, namely Data Mining (DM) in Drug Discovery, Financial Applications.

For example, Merck Anti-Programming Death for Cancer Typing beyond the current protocol (2 mg/kg of BW with IV injection), as well as NIH Human Genome Program, or EU Human Epi-genome Program can apply SDL and ANNs to enhance the Augmented Reality (AR) and Virtual Reality (VR), etc. for Training purpose. There remains BDA in the law and order societal affairs, for example, flaws in banking stock markets, and Law Enforcement Agencies, Police and Military Forces, who may someday require the “chess playing proactive anticipation intelligence” to thwart perpetrators or to spot an adversary in a “See-No-See” Simulation and Modeling, in a man-made situation, for example, inside-traders; or in natural environments, for example, weather and turbulence conditions. Some of them may require a theory of Unsupervised Deep Learning (UDL).

We examine deeper into the deep learning technologies, which are more than just architecture and software to be Massively Parallel and Distributed (MPD), but also Big Data Analysis (BDA). Since 1988 developed concurrently by Werbos (“Beyond Regression: New Tools for Prediction and Analyses” Ph. D. Harvard Univ. 1974), McCelland, and Rumelhart (PDP, MIT Press, 1986). Notably, the key is due to the persistent vision of Geoffrey Hinton and his protégées: Andrew Ng, Yann LeCun, Yoshua Bengio, George Dahl, et al. (cf. Deep Learning, Nature, 2015).

Recently, the hardware of Graphic Processor Units (GPU) has 8 CPUs per Rack and 8×8=64 racks per noisy air-cooled room size at the total cost of millions of dollars. On the other hand, a Massively Parallel Distributed (MPD) GPU has been miniaturized as a back-plane chip.

The software of Backward Error Propagation has made MPD matching the hardware over three decades, do away the inner do-loops followed with the layer-to-layer forward propagation. For example, the Boltzmann machine took a week of sequential CPU running time, now like gloves matching hands, in an hour. Thus, toward UDL, we program on a mini-supercomputer and then program on the GPU hardware and change the ANN software SDL to Biological Neural Networks (BNN) “Wetware,” since the brain is a 3-D Carbon-computing, rather 2-D Silicon computing, it involves more than 70% water substance.

### Robust Associative Memory.

The activation column vector [symbol] of thousands of neurons is denoted in the lower case

[symbol]

=(a₁,a₂, . . . )

after the squash binary sigmoid logic function, or bi-polar hyperbolic tangent logic function within the multiple layer deep learning, with the backward error propagation requiring gradient descent derivatives: Massively Parallel Distributed Processing; superscript l∈(1, 2, . . . )=R¹ denotes l−th layers. The 1K by 1K million pixels image spanned in the linear vector space of a million orthogonal axes where the collective values of all neuron's activations [symbol] ^{[l]} of the next l-th layer in the infinite dimensional Hilbert Space. The slope weight matrix [W^{[l]}] and intercepts [symbol] ^{[l]} will be adjusted based on the million inputs [symbol] ^{[l-1]} of the early layer. The threshold logic at the output will be Eq. 45a Do Away All Do loops using one-step MDP Algorithm within layers will be bi-polar hyperbolic tangent and 32b output layer bipolar sigmoid

[symbol]

^{[l]}=σ([W^{[l]}] [symbol] ^{[l-1]}−\vec{θ}^{[l]}), (45a)

[W^{[l]}=[A^{[l]}]⁻¹=[[l]−([[l]−[A^{[l]}]])]⁻¹≅([I]−[A^{[l]}]])+([I]−[A^{[l]}]])²+ (45b)

Whereas Frank Rosenblatt developed ANN, Marvin Minsky challenged it and coined the term Artificial Intelligence (AI) as the classical rule-based system. Steve Grossberg and Gail Carpenter of Boston Univ. developed the Adaptive Resonance Theory (ART) model that has folded three layers down to itself as the top down and bottom up for local concurrency. Richard Lipmann of MITRE has given a succinct introduction of neural networks in IEEE ASSP Magazine 1984, where he proved that a single layer can do a linear classifier, and multiple layers give convex hull classifier to maximize the Probability of Detection (PD), and minimize the False Alarm Rate (FAR). Stanford Bernie Widrow; Harvard Paul Werbos, UCSD David Rumelhart, Carnegie-Mellon James McClelland, U. Torrente Geoffrey Hinton, UCSD Terence Sejnowski, have pioneered the Deep Learning multiple layers Models, Backward Error Propagation computational (backprop) model. The Output Performance could efficiently be the supervised learning at Least Mean Square (LMS) error cost function of the desired outputs versus the actual outputs. The Performance model could be more flexible by the relaxation process as unsupervised learning at Minimum Herman Helmholtz Free Energy: Brain Neural Networks (BNN) evolves from the Charles Darwinian fittest survival viewpoint, the breakthrough coming when he noted Lyell's suggestion that fossils found in rocks mean that the Galapagos Islands each supported its own variety of finch bird, a theory of evolution occurring by the process of Natural Selection or Natural Intelligence at the isothermal equilibrium thermodynamics due to [1] for a constant temperature brain (Homo sapiens 37° C.; Chicken 40° C.) operated at a minimum isothermal Helmholtz free energy when the input power of pairs transient random disturbance of β-brainwaves may be represented by the degree of uniformity called the entropy S, as indicated by the random pixel histogram are relaxed to do the common sense work for survival.

Healthy brain memory may be modeled as Biological Neural Networks (BNN) serving Massively Parallel and Distributed (MPD) commutation computing, and learning at synaptic weight junction level between j-th and i-th neurons that Donald Hebb introduced a learning model [W_{j,i}] 5 decades ago. The mathematical definition has been given by McCullough-Pitts and Von Neumann introduced the concept of neurons as binary logic element as follows:

$$\begin{matrix}0 \leq \vec{a} = σ ( \vec{X} ) ≡ \frac{1}{1 + exp ( - \vec{X} )} \leq 1 ; \\ \frac{d σ ( x )}{dx} = \vec{a} ( 1 - \vec{a} ) ; & ( 46 a ) \\ - 1 \leq \vec{a} = tan ( i \vec{X} ) = \frac{{e}^{\vec{X}} - {e}^{- \vec{X}}}{{e}^{\vec{X}} + {e}^{- \vec{X}}} = \frac{sinh ( \vec{X} )}{cosh ( \vec{X} )} = tanh ( \vec{X} ) \leq 1 ; \\ \frac{d tanh ( x )}{dx} = 1 - {tanh ( x )}^{2} & ( 46 b )\end{matrix}$$

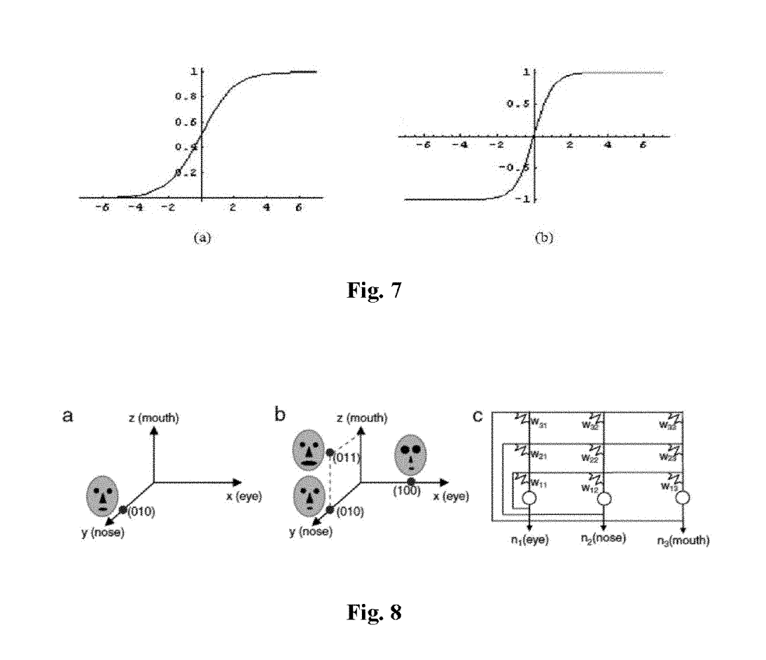

FIG. 7 illustrates the nonlinear threshold logic of activation firing rates (a) for the output classifier and (b) hidden layers hyperbolic tangent.

Thus, the BNN is an important concept. Albert Einstein's brain was kept after his passing away, and it was found that he had 10 billion neurons just like we do, but he also had 100B Glial cells, which are important for performing the house-cleaning servant function to minimize Dementia Alzheimer Disease (DAD), which might have made him different from some of us. These house-keeping smaller glial cells surrounded each neuron output Axon to keep positive ions vesicle moving forward in a pseudo-real time, which repulse one another in line, as one ion is pushed in from one end of the Axon, so that those conducting positive charge ion vesicles have no way to escape but to line up by those insulating Glial cells in their repulsive chain in about 100 Hz, 100 ions per second, no matter how long or short the axon is. The longest axon is about 1 meter longer from the neck to the toe in order to instantaneously issue the order from the HVS to run away from the tiger. The insulated fatty acids, Myelin sheath, known to be Glial cells, are among those 6 types of Glial Cells.

The Glial Cells (glue force) are derived for the first time when the internal energy E_{int.} is expanded as the Taylor series of the internal representation [symbol] related by synaptic weight matrix [W_{i,j}] to the Power of the Pairs [symbol] =[W_{i,j}] [symbol] ₚₐᵢᵣ of which the slope turns out to be biological Glial cells identified by the Donald O. Hebb learning rule

$$< {\vec{g}}_{j} >= - < \frac{\partial {H}_{int .}}{\partial {\vec{D}}_{j}} > , \qquad ( 47 )$$

where the j-th Dendrite tree sum [symbol] of all i-th neurons whose firing rates are proportional to the internal degree of firing rate Sᵢ called the Entropy uniformity:

< [symbol] >=<Σᵢ[W_{i,j}] [symbol] >

from which we have verified Donald O. Hebb learning rule, in the Ergodicity ensemble average sense, who formulated it six decades ago in the brain neurophysiology. Given a time-asynchronous increment=|Δt|, the learning plasticity adjustment is proportional to the pre-synaptic firing rate \vec{S}ᵢ and the post synaptic glue force [symbol] .
Theorem of the Asynchronous Robot Team and their Convergence

If and only if there exists a global optimization scalar cost function H_{int.} known as the Helmholtz Free Energy at isothermal equilibrium to each robot member, then each follows asynchronously its own clock time in Newton-like dynamics at its own time frame “tⱼ=εⱼt”; εᵢ≥1 time causality with respect to its own initial boundary conditions with respect to the global clock time “t”

$$\frac{d [ {W}_{i , j} ]}{{dt}_{j}} = - \frac{\partial {H}_{int .}}{\partial [ {W}_{i , j} ]} ; \qquad ( 48 )$$

Proof: The overall system is always convergent guaranteed by a quadratic A. M. Lyaponov force function:

$$\frac{dH}{dt} = {\sum }_{j} \frac{\partial H}{\partial [ {W}_{i , j} ]} {ɛ}_{j} \frac{d [ {W}_{i , j} ]}{{dt}_{j}} = - {\sum }_{j} {ɛ}_{j} {\vert \frac{\partial H}{\partial [ {W}_{i , j} ]} \vert}^{2} \leq 0 ; \\ {ɛ}_{j} \geq 1 time causality . Q . E . D . \qquad$$

$$Δ [ {W}_{i , j} ] = \frac{\partial [ {W}_{i , j} ]}{\partial {t}_{j}} η = - \frac{\partial H}{\partial [ {W}_{i , j} ]} η = - \frac{\partial H}{\partial {\vec{D}}_{j}} \cdot ( \frac{\partial {\vec{D}}_{j}}{\partial [ {W}_{i , j} ]} ) η ≡ {\vec{g}}_{j} {\vec{S}}_{1} η ( Bilinear Hebb Rule ) \qquad ( 49 )$$

This Hebb Learning Rule may be extended by chain rule for multiple layer “Backprop algorithm” between neurons and glial cells

<[W_{i,j}]>=<[W_{i,j}]^{old}>+ [symbol] η (50)

We can conceptually borrow from Albert Einstein the space-time equivalent special relativity to trade the individual time life experience with the spatially distributed experiences gathered by Asynchronously Massively Parallel Distributed (AMPD) Computing through Cloud Databases with variety initial and boundary conditions. Also, Einstein said that “Science has nothing to do with the truth (a domain of theology); but the consistency.” That's how we can define the Glial cells for the first time consistently Eq. (47).

### Hippocampus Associative Feature Memory: Write Outer Product and Read by Matrix Inner Product.

From 1000×1000 face image pixels, the three Grand Mother (GM) feature neurons are extracted representing the eye size, nose size, and mouth size in a transpose of a row vector. As shown in FIG. 8, an associative memory features either Fault Tolerance with one bit error out of three bits about 33% or the generalization to within 45 degree angle of orthogonal feature storage. These are two sides of the same coin of Natural Intelligence. For GM features=[eye,nose,mouth]^{T}:

$$\begin{matrix}[ AM ] = [ \begin{matrix}( \begin{matrix}1 \\ 0 \\ 0\end{matrix} ) & ( 1 & 0 & 0 )\end{matrix} ] aunt + [ \begin{matrix}( \begin{matrix}0 \\ 1 \\ 0\end{matrix} ) & ( 0 & 1 & 0 )\end{matrix} ] uncle = [ \begin{matrix}1 & 0 & 0 \\ 0 & 0 & 0 \\ 0 & 0 & 0\end{matrix} ] + [ \begin{matrix}0 & 0 & 0 \\ 0 & 1 & 0 \\ 0 & 0 & 0\end{matrix} ] = [ \begin{matrix}1 & 0 & 0 \\ 0 & 1 & 0 \\ 0 & 0 & 0\end{matrix} ] & ( 51 ) \\ [ AM ] ( \begin{matrix}0 \\ 1 \\ 1\end{matrix} ) smile uncle = [ \begin{matrix}1 & 0 & 0 \\ 0 & 1 & 0 \\ 0 & 0 & 0\end{matrix} ] ( \begin{matrix}0 \\ 1 \\ 1\end{matrix} ) = ( \begin{matrix}0 \\ 1 \\ 0\end{matrix} ) = remain big nose uncle & ( 52 )\end{matrix}$$

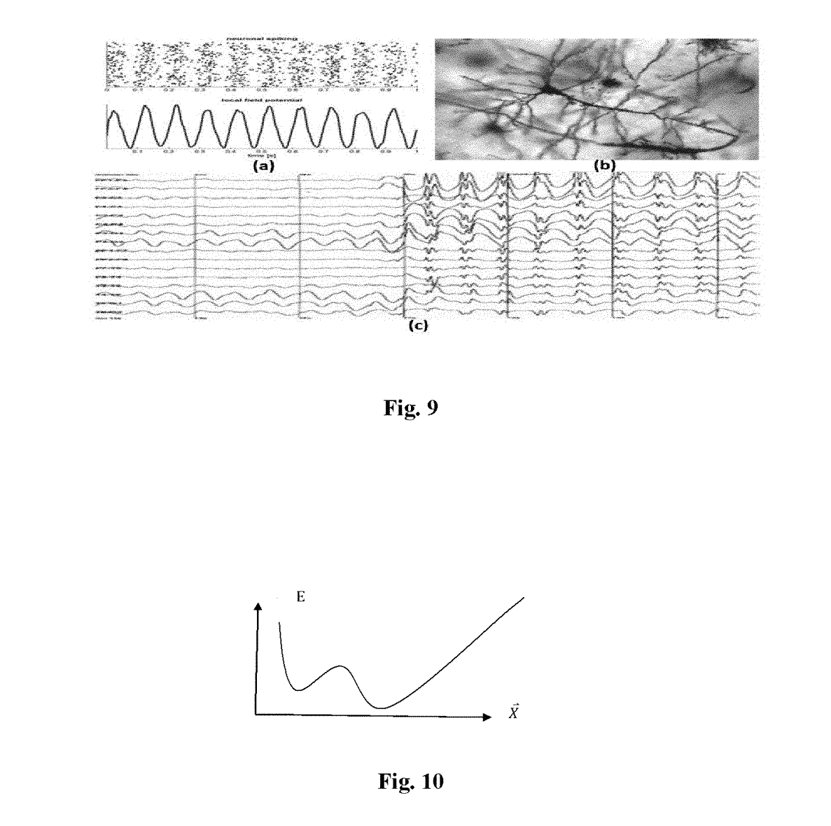

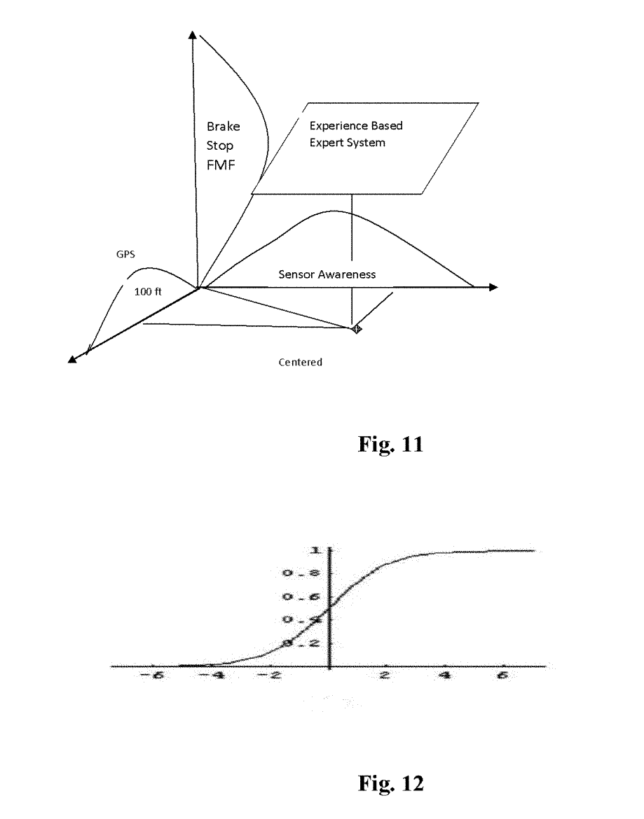

Brain disorders may be computationally represented the population density waves in the epileptic seizure diagrams shown in FIG. 9. As shown, there is no travelling electromagnetic wave in the BNN, and instead there is a neuronal population of firing rates observed 5 decade ago by D.O. Hebb: “linked together, firing together” (LTFT), which is why the dot density appears to be modulated from on 100 Hz to off less than 50 Hz.

A smaller sized feature processing after the back of our head Cortex 17 area V1-V4 layers of feature extraction, these feature feed to underneath the control Hypothalamus Pituitary Gland Center there are two walnut/kidney shape Hippocampus for the Associative Memory storage after the image post-processing.

### Simulation

First, the analyticity is defined to be represented by a unique energy/cost function for those fuzzy attributes in term of the membership function. The causality is defined to be the 1-1 relationship from the initial value to the answer of gradient descent value. The experience is defined to be analytical, as given a non-convex energy function landscape. As shown in FIG. 10, for the nonconvex energy landscape, the horizontal vector abscissas could be the input sensor vectors.

Unification of Biological Neural Networks with Walter Freeman Ion Dynamic Negative Diffusion Equation and Lotfi Zadeh Postulated Human Fuzzy Membership Function

Theorem: The human brain biological neural network (BNN) is unified with isothermal natural intelligent (NI) with Lotfi Zadeh fuzzy logic and Walter Freeman chaotic ion diffusion dynamics. Proof: The human brain has a two-state (Dendrite to Axon) potential drop from the Maxwell-Boltzmann Canonical probability, which turns out to yield the normalized sigmoid function a of a neuron firing rate (see FIG. 12). This was first observed by McCullough & Warren Pitts prior to John von Neumann designing computer logic. We now know that H_{Brain} is related to the constant temperature Tₒ=37 C=310K thermodynamic Helmholtz Free Energy H_{Brain}=E_{Brain}−TₒS

$$exp ( - \frac{{H}_{1}}{{k}_{b} {T}_{o}} ) / exp ( - \frac{{H}_{1}}{{k}_{B} {T}_{o}} ) + exp ( - \frac{{H}_{2}}{{k}_{B} {T}_{o}} ) = 1 / [ exp ( \frac{Δ {H}_{1 , 2}}{{k}_{B} {T}_{o}} ) + 1 ] = σ ( \frac{Δ {H}_{1 , 2}}{{k}_{B} {T}_{o}} ) = \{ \begin{matrix}1 , \frac{Δ {H}_{1 , 2}}{{k}_{B} {T}_{o}} \to ∞ \\ 0 , \frac{Δ {H}_{1 , 2}}{{k}_{B} {T}_{o}} \to - ∞\end{matrix} \qquad ( 53 )$$

Collorary 1: The Riccatti nonlinear 1^{st} order differential equation is derived from the Maxwell-Boltzman two-state weighted sum and its exact solution turns out to be the sigmoid threshold function σ(x):

$$Let x = \frac{Δ {H}_{1 , 2}}{{k}_{B} {T}_{o}} ,$$

then

$$\frac{d σ ( x )}{dx} = {σ ( x )}^{2} - σ ( x ) ; σ ( x ) = \frac{1}{exp ( x ) + 1} \qquad ( 54 )$$

Proof:

$$\frac{d σ ( x )}{dx} = {\frac{d}{dx} [ exp ( x ) + 1 ]}^{- 1} = - {1 [ exp ( x ) + 1 ]}^{- 2} exp ( x ) = - {1 [ exp ( x ) + 1 ]}^{- 2} \{ - 1 + ( exp ( x ) + 1 ) \} = {σ ( x )}^{2} - σ ( X ) Q . E . D .$$

Corollary 2: An F. Hopf (Baker) Transform can linearize the first-order Ricatti nonlinear differential equation to an A. Einstein negative diffusion equation Eq. (56), causing chaos in the brain.

Proof:

$$\begin{matrix}σ ( x ) = - \frac{{ϕ ( x )}^{′}}{ϕ ( x )} \\ LHS = \frac{d σ ( x )}{dx} = - \frac{{ϕ}^{″}}{ϕ} + \frac{{( {ϕ}^{′} )}^{2}}{{ϕ}^{2}} = RHS = \frac{{( {ϕ}^{′} )}^{2}}{{ϕ}^{2}} + \frac{{ϕ ( x )}^{′}}{ϕ ( x )} & ( 55 ) \\ {ϕ}^{′} = - {ϕ}^{″} \\ Q . E . D . & ( 56 )\end{matrix}$$

In summary, the two-state normalization Maxwell-Boltzmann phase space distribution is derived to be equivalent to an ion-current negative diffusion equation, as proposed first in ad-hoc fashion by Walter Freeman. By means of the Hopf transform, the sigmoid threshold logic can be applied, which turns out to be a fuzzy membership function (FMF) of beauty or not. The two state-normalization can be illustrated as follows: In the scale of Greek mythology of Helen of Troy whose beauty has sunk 1000 ships, Eve of Adam should sink only one ship: Noah's Ark; Egypt's Cleopatra sank 10 ships; China's Xi-Shi ( [symbol] ) sank 100 fish and swallows; your sweet heart might be in the limit of an infinite ships phase transition, which could wreck the scholarship.

The beauty Fuzzy Logic Membership Function turns out to be a sigmoid. Since the beauty is in the eyes of the beholder, then it follows that a two-state, beauty or not determination, in terms of Maxwell-Boltzmann phase space distribution derives the sigmoid function, Eq. (53). As previously mentioned, the 1^{st} Generation AI is the Marvin Minsky original proposed rule-based system. This system cannot pass the Alan Turing test as to whether a human or a machine is at the other end. The 2^{nd} Generation AI is the Google-developed Alpha Go learnable rule-based system, which beat a human expert at the sophisticated Go game. However, it cannot adequately drive an autonomous vehicle and recently killed a pedestrian doing so. The 3^{rd} Generation AI system exemplified by the present invention provides a machine that augments human possibility fuzzy thinking, so that it understands humans and will able to co-exist within human society.

It will be demonstrated that the biological brain isothermal natural intelligence (NI) can coexist with Lotfi Zadeh fuzzy logic and healthy sigmoid logic in terms of either the positive diffusion of Albert Einstein or the negative diffusion dynamics of calcium ions according to Walter Freeman.

Beginning with the thermodynamic isothermal equilibrium at minimum Helmholtz Free Energy H_{Brain}=E_{Brain}−Tₒ S, H_{Brain} is related at the average constant brain temperature Tₒ=37 C=310K, of which any input and output are local fluctuations of thermal transient heat at two-state normalization.

$$exp ( - \frac{{H}_{1}}{{k}_{B} {T}_{o}} ) / exp ( - \frac{{H}_{1}}{{k}_{B} {T}_{o}} ) + exp ( - \frac{{H}_{2}}{{k}_{B} {T}_{o}} ) = 1 / [ exp ( \frac{Δ {H}_{1 , 2}}{{k}_{B} {T}_{o}} ) + 1 ] = σ ( \frac{Δ {H}_{1 , 2}}{{k}_{B} {T}_{o}} ) = \{ \begin{matrix}1 , \frac{Δ {H}_{1 , 2}}{{k}_{B} {T}_{o}} \to ∞ \\ 0 , \frac{Δ {H}_{1 , 2}}{{k}_{B} {T}_{o}} \to - ∞\end{matrix} \qquad ( 57 )$$

FIG. 12 shows the standard McCullough-Pitt Sigmoid Threshold Logic of Eq. (57), derived from two-state normalization of the Maxwell-Boltzmann distribution function.

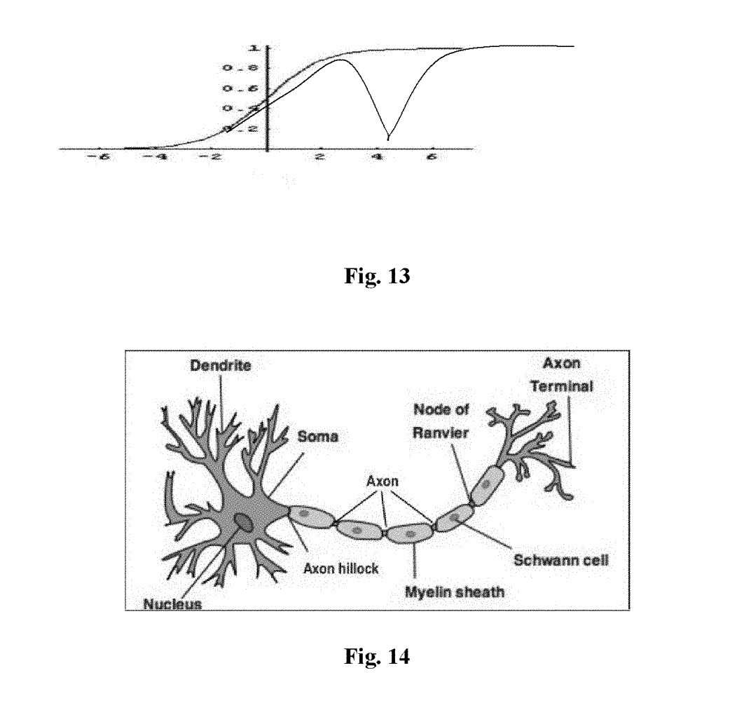

As shown in FIG. 13, possible chaos leading to a fuzzy logic chaotic neural net results from piecewise negative N-shaped logic in the sigmoid logic. The dip is due to negative diffusion in ion transmission at Neuron Axon Hillock.

Theorem: The Riccati nonlinear 1^{st} order differential equation is derived from the Maxwell-Boltzman two-state weighted sum and its exact solution turns out to be the sigmoid threshold function σ(X):

$$Let x = \frac{Δ {H}_{1 , 2}}{{k}_{B} {T}_{o}} ,$$

then

$$\frac{d σ ( x )}{dx} + σ ( x ) = {σ ( x )}^{2} ; σ ( x ) = \frac{1}{exp ( x ) + 1} \qquad ( 58 )$$

Proof:

$$\frac{d σ ( x )}{dx} = {\frac{d}{dx} [ exp ( x ) + 1 ]}^{- 1} = - {1 [ exp ( x ) + 1 ]}^{- 2} exp ( x ) = - {1 [ exp ( x ) + 1 ]}^{- 2} \{ - 1 + ( exp ( x ) + 1 ) \} = {σ ( x )}^{2} - σ ( X ) Q . E . D$$

Theorem: A Hopf (baker) transform can linearize the first order Riccati quadratic-nonlinear differential equation to the A. Einstein diffusion equation Eq. (56). (Note that in dynamical systems theory, the baker's map is a chaotic map from the unit square into itself. It is named after a kneading operation that bakers apply to dough: the dough is cut in half, and the two halves are stacked on one another, and compressed).

Proof: Introducing the calcium ion φ(x) concentration, the slope of the logarithmic concentration can be set to be a two-state normalization sigmoid:

$$σ ( x ) = - \frac{{ϕ ( x )}^{′}}{ϕ ( x )} = - \frac{d}{dx} log ϕ ( x )$$

$$LHS = \frac{d σ ( x )}{dx} = - \frac{{ϕ}^{″}}{ϕ} + \frac{{( {ϕ}^{′} )}^{2}}{{ϕ}^{2}} = RHS = \frac{{( {ϕ}^{′} )}^{2}}{{ϕ}^{2}} + \frac{{ϕ ( x )}^{′}}{ϕ ( x )}$$

$${ϕ}^{′} = - {ϕ}^{″}$$

With respect to a local wave front, the streaming term is set to zero at the wave front, for example, sitting on the smoke outer-most wave front shown in FIG. 3 where smoke particles will be diffusive.

$$\frac{d ϕ}{dt} = {ϕ}_{t} + {ϕ}^{′ } = 0 ; ⇒ {ϕ}^{′} ≅ - {ϕ}_{t}$$

Thus, at the local wave front of the neuro-transmitted calcium ions the diffusion equation of calcium ion concentration φ(x) satisfies Albert Einstein's Brownian motion with positive diffusion constant D>0.

φₜ=Dφ″

The chaos comes from a piece-wise negative diffusion. It begin at the neuron, having an output (axon), and an input (dendrite). The root of the axon is called the axon hillock (see FIG. 14), which serves as the calcium ion reservoir for threshold logic as the membrane potential gate level. If its behavior becomes temporarily disordered with the sink of ions so that it has a reduced output, this results in the negative dip, accounting for the negative diffusion.

It is important to differentiate temporary chaos generating fuzzy logic from pathological sickness. The control of firing rates is done by the neuroglia cells, for example, schwann cells, one of the four kinds of neuroglia cells, which has built an insulating myelin sheath made of protein fatty acids for modulation. When the myelin sheath is mistaken for a virus protein, then antibodies will attack it, resulting in multiple sclerosis, an auto-immune disease. In such a case, the ion current will short circuit and the person can no longer walk, because the command cannot reach from the head to the toe.

A brain tumor is likewise caused by a malfunction of neuroglia called glioma, a nonstop mitosis cell growth, such as that experienced by former Arizona Senator John McCain, currently in the 4^{th} terminating stage according to United Nation WHO classification. This is a divergence of the mathematical definition due to input dendrite sum Dj shrinkages as the cell density increases without bound but the brain free energy is not likewise reduced.

$${g}_{j} = - \frac{{dH}_{brain}}{{dD}_{j}} ↑ ∞ . Dj = {\sum }_{k} [ {W}_{j , k} ] {S}_{k} \to 0$$

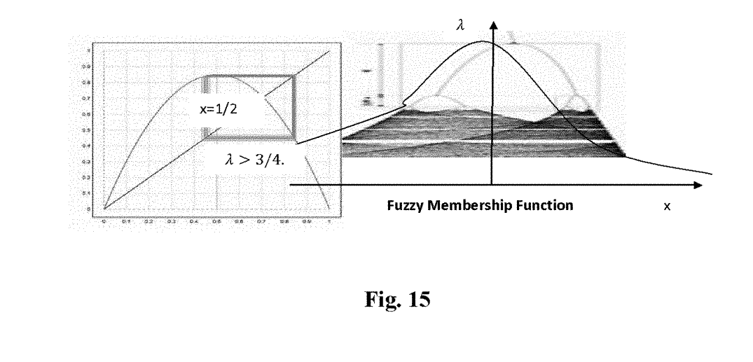

FIG. 15 shows a Michel Feigenbaum bifurcation logistic map.

yₙ₊₁=4λxₙ(1−xₙ); n=1,2,3, . . . xₙ₊₁=yₙ₊₁

For an AV application, we need to compute the Langevin Brownian diffusion equation for the car weight and the tire friction coefficient f.

The Langevin equation of the car momentum [symbol] = [symbol] , with tire-road friction coefficient f, and car-body aerodynamic fluctuation force [symbol] (t):

$$\begin{matrix}\frac{d \vec{P}}{dt} = - f \vec{P} + \vec{F} ( t ) & ( 59 ) \\ < \vec{F} ( t ) \cdot \vec{F} ( {t}^{′} ) >= 2 {k}_{B} f δ ( t - {t}^{′} ) & ( 60 )\end{matrix}$$

This possible membership concept is important for exploration of large data, which often don't have definitive membership relations when partial analysis of the data is being done without definite knowledge that classifies all the subsets of the data. For example, “the young and beautiful” is a much sharper possibility than either “the young” or “the beautiful”. When averaging over spatial cases, the average of the Experience Based Expert System is obtained in order to elucidate i-AI.

Brake FMF∩Sensor Awareness FMF∩GPS space−time FMF=Experience σ(stop)

With reference to FIG. 5, and as mentioned previously, a Fuzzy Membership Function is an open set and cannot be normalized as a probability but instead as a possibility. As illustrated in the drawing, the range of values for a quality such as “young” are distributed and not at all well-defined. For example, UC Berkeley Prof. Lotfi Zadeh passed away at the age of 95 and Walter Freeman at age 89. To them, 80 might have been “young.” Similarly, “beauty” is in the eye of beholder. According to Greek mythology, Helen of Troy sank a thousand ships, whereas in Egypt Cleopatra sank a hundred ships, and in the Bible Eva sank but one ship.

As shown in FIG. 6, a utility of FMF logic is the Boolean Logic of Union∪& Intersection∩of open set Fuzzy Membership Functions (FMF), which cannot be normalized as a probability. The Boolean logic is sharp, not fuzzy.

Unfortunately, the term “Fuzzy (membership function) Logic” is often shortened as “Fuzzy Logic,” which is a misnomer. Logic cannot be fuzzy, but the set can be an open set of all possibilities. Szu has advocated a bifurcation of chaos as a learnable FMF, making the deterministic chaos as the learnable dynamics of FMF (cf. Szu at Max Planck: ResearcGate.net).

Consequently, a car will drive through an intersection slowly even when the traffic light is red if the conditions indicate that this is the best course of action, such as at midnight in the desert and without any incoming cars. Such an RB becomes flexible as EBES, and replacing RB with EBES is a natural improvement of AI, allowing, for example, a driverless car to change the inflexible rule of stopping at a red light to allow gliding through the red light when circumstances indicate that this is prudent.

### REFERENCES

[1]. Soo-Young Lee, Harold Szu, “Design of smartphone capturing subtle emotional behavior,” MOJ Appl. Bio Biomech. 2017, 1(1), pp. 6, 16.
[2] Jeffrey Mervis, “No So Fast,” Science, V. 358, pp. 1370-1374; Matthew Hutson, “A Matter of Trust”, Science, V. 358, pp. 1375-1377;
[3] Andrew Ng, “The State of Artificial Intelligence,” MIT Review, YouTube; Similar to Internet Company: Product-Website-Users (e.g. Google, Baidu); AI Company: Data-Products-Users positive cycle.
[4] Richard Lipmann “Introduction to Computing with Neural Nets,” IEEE ΔSSP Magazine April 1987
[5] Panel Chair Steve Jurvetson, DFJ Ventures, VLab, Stanford Graduate School of Business, “Deep Learning Intelligence from Big Data,” YouTube, Sep. 16, 2014. Unlabelled Data□ Cat; Moore's Law□ curve on log plot□ double exponential;
[6] Harold Szu Mike Wardlaw, Jeff Willey, Kim Scheff, Simon Foo, Henry Chu, Joe Landa, Yufeng Zheng, Jerry Wu, Eric Wu, Hong Yu, G. Seetharamen, Jae Cha, John Gray, “Theory of Glial Cells & Neurons Emulating Biological Neural Networks (BNN) for Natural Intelligence (NI) Operated Effortlessly at a Minimum Free Energy (MFE)”, MedCrave J. Appl. Bionics BioMech, V1(1) 2017
[7] Harold Szu, Gyu Moon, “How to Avoid DAD?” MedCrave J. Appl. Bionics BioMech, V2(2), 2018
[8] James McCelland, & David Rumelhart (PDP group, MIT Press, 1986)
[9] Geoffrey Hinton, Yann LeCun, Yoshua Bengio, “Deep Learning,” Nature, 2015.
[10] G. Cybenko “Approximation by Superposition of a Sigmoidal Functions,” Math. Control Signals Sys. (1989) 2: 303-314; S. Ohlson: “Deep Learning: How the Mind overrides Experience,” Cambridge Univ. Press 2006
[11] A. N. Kolmogorov, “On the representation of continuous functions of many variables by superposition of continuous function of one variable and addition,” Dokl. Akad. Nauk, SSSR, 114(1957), 953-956

I claim:

1. An experience-based expert system, comprising:
an open-set neural net computing sub-system, which includes massive parallel distributed hardware configured to process associated massive parallel distributed software configured as a natural intelligence biological neural network that maps an open set of inputs to an open set of outputs.

2. The system of claim 1, wherein the neural net computing sub-system is configured to process data according to the Boltzmann Wide-Sense Ergodicity Principle.

3. The system of claim 2, wherein the neural net computing sub-system is configured to process input data received on the open set of inputs to determine an open set of possibility representations and to generate a plurality of fuzzy membership functions based on the representations.

4. The system of claim 3, wherein the neural net computing sub-system is configured to generate output data based on the fuzzy membership functions and to provide the output data at the open set of outputs.

5. The system of claim 4, further comprising an external intelligent system coupled for communication with the neural net computing sub-system to receive the output data and to make a decision based at least in part on the received output data.

6. The system of claim 5, wherein the external intelligent system includes an autonomous vehicle.

7. The system of claim 6, wherein the decision determines a speed of the autonomous vehicle.

8. The system of claim 6, wherein the decision determines whether to stop the autonomous vehicle.

9. The system of claim 5, further comprising inputs configured to receive global positioning system data and cloud database data.

10. The system of claim 9, wherein the neural net computing sub-system is configured to perform a Boolean algebra average of the union and intersection of the fuzzy membership functions, the global positioning system data, and the cloud database data.

11. A method of mapping an open set of inputs to an open set of outputs, comprising:
providing an open-set neural net computing sub-system having massive parallel distributed hardware; and
configuring the open-set neural net computing sub-system to process associated massive parallel distributed software configured as a natural intelligence biological neural network.

12. The method of claim 11, further comprising configuring the neural net computing sub-system to process data according to the Boltzmann Wide-Sense Ergodicity Principle.

13. The method of claim 12, further comprising configuring the neural net computing sub-system to process input data received on the open set of inputs to determine an open set of possibility representations and to generate a plurality of fuzzy membership functions based on the representations.

14. The method of claim 13, further comprising configuring the neural net computing sub-system to generate output data based on the fuzzy membership functions and to provide the output data at the open set of outputs.

15. The method of claim 14, further comprising coupling an external intelligent system for communication with the neural net computing sub-system to receive the output data and to make a decision based at least in part on the received output data.

16. The method of claim 15, wherein the external intelligent system includes an autonomous vehicle.

17. The method of claim 16, wherein the decision determines a speed of the autonomous vehicle.

18. The method of claim 16, wherein the decision determines whether to stop the autonomous vehicle.

19. The method of claim 15, further comprising configuring inputs to receive global positioning system data and cloud database data.

20. The method of claim 19, further comprising configuring the neural net computing sub-system to perform a Boolean algebra average of the union and intersection of the fuzzy membership functions, the global positioning system data, and the cloud database data.
